(19) United States
(12) Patent Application Publication
(10) Pub. No.: US 2008/0202993 A1
(43) Pub. Date: Aug. 28, 2008

(54) METHOD AND APPARATUS FOR TREATING SOLID WASTE

(75) Inventors: Michael H. Eley, Huntsville, AL (US); Donald E. Malley, Poplarville, MS (US)

Correspondence Address: Charles F. Reidelbach, Jr.;Higgs, Fletcher & Mack, LLP, Suite 2600, 401 West A Street, San Diego, CA, 92101, US

(73) Assignee: Clean Earth Solutions, Inc., Spring Valley, CA (US)

(21) Appl. No.: 12/017,866

(22) Filed: Jan. 22, 2008

Related U.S. Application Data
(60) Provisional application No. 60/881,711, filed on Jan. 22, 2007.

(51) Int. Cl. B01D 35/14; B01D 35/31; B01D 15/00; B01D 21/30

(52) U.S. Cl. 210/130; 210/173; 210/199; 210/137; 210/135

(57) ABSTRACT

An apparatus for treating solid waste to produce a biomass product includes a cylindrical vessel includes a cylindrical vessel comprising a loading doorway and a discharge doorway at opposite ends of the cylindrical vessel. At least two drive tires are mounted on the cylindrical vessel perpendicular to the cylindrical axis. The drive tires each include a smooth exterior surface for rotating the cylindrical vessel without gear teeth and without sprocket teeth. A drive mechanism is coupled to the drive tires for rotating the cylindrical vessel around the cylindrical axis. The drive mechanism includes drive wheels that support and provide torque to the cylindrical vessel from a contact surface on each of the drive wheels that contacts the exterior surface of the drive tires.

### CROSS-REFERENCE TO RELATED APPLICATIONS

This application claims the benefit of U.S. Provisional Patent Application No. 60/881,711 filed on Jan. 22, 2007.

### BACKGROUND OF THE INVENTION

1. Field of the Invention

The present invention is directed to a method and apparatus for the treatment of solid waste streams, including municipal solid waste (“MSW”), to facilitate the separation and recovery of pulp and paper material from constituent non-biomass components and to produce a homogenous cellulosic biomass product that may be recycled in a variety of ways.

2. Description of Related Art

Many solid waste streams, particularly MSW, contain significant quantities of pulp and paper materials that are contaminated with food wastes, yard wastes, textiles, plastics, metals, glass, and other non-biomass components. Such contamination makes the separation and recovery of clean pulp and paper products from the waste streams very difficult, if not economically unfeasible. However, it is incumbent upon an environmentally conscious society and its governments to minimize waste disposal and to increase the use of recycled materials. Recovery and recycling of the pulp and paper materials and other biomass materials from wastes are equally important to the recovery and recycling of the non-biomass components of wastes.

### SUMMARY OF THE INVENTION

In one embodiment, an apparatus for treating solid waste to produce a biomass product includes:

a cylindrical vessel including a loading doorway and a discharge doorway at opposite ends of the cylindrical vessel;

a first detachable door for loading the solid waste into the cylindrical vessel and for sealing the loading doorway under pressure;

a second detachable door for unloading the biomass product from the cylindrical vessel and for sealing the discharge doorway under pressure;

a helical flighting affixed to an interior wall of the cylindrical vessel for mixing and agitating the solid waste and the biomass product and for conveying the solid waste and the biomass product between the loading doorway and the discharge doorway when the cylindrical vessel is rotated around a cylindrical axis of the cylindrical vessel;

at least two drive tires mounted on the cylindrical vessel perpendicular to the cylindrical axis, the drive tires each comprising a smooth exterior surface for rotating the cylindrical vessel on the drive mechanism without gear teeth and without sprocket teeth; and

a drive mechanism coupled to the drive tires for rotating the cylindrical vessel around the cylindrical axis; the drive mechanism further comprising drive wheels that support and provide torque to the cylindrical vessel from a contact surface on each of the drive wheels that contacts the exterior surface of the drive tires.

### BRIEF DESCRIPTION OF THE DRAWINGS

FIG. 1 illustrates a side view of a vessel for an apparatus for producing a homogenous cellulosic biomass product;

FIG. 2 illustrates a cross-sectional view of a drive tire support for the vessel of FIG. 1;

FIG. 3A illustrates a side view of a drive mechanism for the vessel of FIG. 1;

FIG. 3B illustrates an end view of the drive mechanism of FIG. 3A;

FIG. 4 illustrates a side view of a steam flow controller for the vessel of FIG. 1;

FIG. 5 illustrates a side view of a steam distribution conduit for the steam flow controller of FIG. 4;

FIG. 6 illustrates a side view of a steam sparging conduit for the steam flow controller of FIG. 4;

FIG. 7 illustrates a side view of a steam sparging conduit cleanout and bypass for the steam flow controller of FIG. 4;

FIG. 8 illustrates a side view of an exhaust and preheating system for the steam flow controller of FIG. 4; and

FIG. 9 illustrates a flow chart for the separation of materials from the processed solid waste discharged from the process vessel of FIG. 1.

### DETAILED DESCRIPTION OF THE ILLUSTRATED EMBODIMENTS

It is desirable to have a method of disposal or treatment of wastes that can recover recyclable materials in a manner that is both economical and environmentally safe. Although landfilling has been a popular and an economical method of waste disposal, many older landfills have emitted and continue to emit greenhouse gases to the atmosphere and have contaminated ground and surface water with leachate. Newer and more stringent government regulations have improved landfill waste disposal methods by requiring impervious liners in an attempt to prevent leachate contamination of ground and surface water and requiring installation of landfill gas collection systems to minimize greenhouse gas emissions. The methane gas component of landfill gas can be used as a fuel, but methane gas is the only recoverable product of landfill waste disposal. The components in the landfill are for the most part lost raw materials for industry; the value of the landfill property itself for agricultural, residential, or industrial activity is essentially lost for extended time periods, if not forever; and neighboring property values are significantly reduced.

Incineration of wastes has become a method of choice for waste disposal, where landfill disposal is prohibitive due to population density, lack of availability of land, property values, and environmental regulations. Incinerators recover energy from the combustible components of the waste, usually to produce electricity. Waste incineration is not without both economic and environmental consequences. Airborne particulates and gases are produced and very expensive air pollution equipment is installed to minimize air emissions from incinerators. The particulate material captured from incinerator exhausts, called “fly ash”, is often contaminated with toxic heavy metals, and may require disposal as hazardous waste. The bottom ash from incineration contains most of the non-biomass materials, and although significantly reduced in volume, this material usually represents 30% or more of the original waste by weight. The bottom ash is sometimes combined with fly ash to make the latter less toxic, but the resultant waste ash must be landfilled in specially designed sites, known as monofills. The costs of waste incineration are usually several times more expensive than waste landfilling, but landfilling of the potentially hazardous ash is required.

In an effort to reduce the quantities of solid wastes currently being landfilled or incinerated, there is tremendous public interest in attempting to recycle various components of solid wastes, particularly MSW. This includes a variety of collection methods, such as buy-back centers, convenience centers, and curbside collection for selected waste components. Although this effort is making an impact on the quantities of waste requiring disposal, it too has economic and environmental consequences. Individuals and businesses must source segregate and in some cases clean the waste components to be recycled. There are significant quantifies of newsprint, corrugated cardboard, and other pulp and paper materials being recycled, but as the quantities of these pulp and paper recyclables increase, their market value decreases, which makes the cost of recovery less profitable, or in some cases more expensive than disposal. Other selected materials that are also recycled include metals, glass, and certain plastics. Ferrous and non-ferrous metals have good value for recycling, but in the case of metal food and beverage containers, these require cleaning which puts additional burden on wastewater treatment systems. Glass containers must also be washed for recycling with similar wastewater contamination, but the value of glass for recycling in most locations, and unless color sorted, is below the cost of transport to the glass recycling plants. Only certain plastics are currently recycled in any significant quantities, and again these require cleaning prior to recycling. PETE (#1) and HDPE (#2) are currently the only plastics valuable enough for recycling. The costs of manpower, transportation fuel, and energy required to operate these types of recycling programs is enormous, and some doubt their environmental benefits. Taking all of these points into consideration, only about 20-25% of the waste stream is recyclable using these methods, and recycling programs are struggling to achieve those amounts. One must also consider that recycling programs do not even exist in many parts of the United States or the world.

Some efforts are now being made to separate and recover various components of commingled solid wastes for recycling prior to disposal at landfills and incinerators. Some waste receiving and recycling facilities are located at transfer stations, where small volume waste haulers deliver their waste for compaction and transport to disposal facilities on large volume trucks. There are even some dedicated waste recycling facilities that also serve as transfer stations. These facilities operate to recover valuable components from the waste stream and to minimize their costs of waste transport and/or disposal. Recovery rates of recyclables even at dedicated waste recycling facilities are typically 25-40% by weight.

The single most important components of solid wastes or MSW are pulp and paper materials, and for the most part, such materials are not typically recovered. In spite of efforts to recover such materials with recycling programs prior to their disposal, pulp and paper materials comprise in the range of 40-60% of MSW by weight or even higher percentages by volume. Therefore, the recovery of these materials and other biomass, such as food wastes and soft yard wastes that comprise an additional 5 - 25% of MSW by weight, is extremely important in any method of treatment. These biomass materials must be recovered and recycled to have a serious impact on reduction of wastes being landfilled or incinerated. It is also important that the recovered biomass materials be sterile, uniform in composition and quality, and stable in storage or shipment. A homogenous cellulosic biomass product from solid wastes or MSW must also have markets for conversion into or incorporation into useful end products. A method and system of waste processing and recycling is needed to maximize the recovery of recyclable components from the waste stream, whether or not any prior separation, cleaning, and/or special collection of selected components has been implemented. Recovery rates of recyclables should be in excess of 80% by weight and volume, which means that the pulp and paper materials must be recovered in some recyclable form. The method and system needs to be economical and cost competitive with state-of-the-art waste recycling and disposal techniques. The method and system needs to be environmentally safe; producing little or no wastewater, gaseous emissions, or solid residual wastes. The improved method and system described below is intended to meet or exceed all of these above needs.

In one embodiment, an apparatus for treating solid waste containing diverse pulp and paper materials, such as waste paper and municipal solid waste (“MSW”), produces a homogenous cellulosic biomass product. The apparatus includes a cylindrical process vessel with conical ends terminating with a doorway equipped with a detachable door for closure of the doorway and a sealing mechanism to allow the process vessel to be pressurized with steam. The cylindrical process vessel may be rotated in either rotational direction about its cylindrical axis and includes a helical flighting affixed to the interior wall of the cylindrical vessel to serve as a means of conveyance and mixing of the vessel contents when the vessel is rotated about its cylindrical axis. The process vessel advantageously includes a door at a loading end and a discharge end, in contrast to devices of the prior art in which the process vessel has only a single door. The process vessel including two doors allows the processing to be streamlined in one direction, with one door serving as the inlet or the loading end for introducing solid wastes into the vessel interior and the second door on the opposite end of the cylindrical process vessel serving as the outlet or discharge end for discharging the processed solid waste. Such an arrangement allows permanent installation of the equipment used for loading the waste to be processed on the loading end of the cylindrical vessel and the equipment for unloading the processed materials on the opposite or discharge end of the cylindrical vessel. This arrangement also prevents contamination of the sterilized processed materials with unsterilized wastes yet to be processed.

Another advantage over prior art waste treatment systems is the external means for rotation of the process vessel, which may consist of drive tires mounted perpendicular to the exterior wall and to the longitudinal axis of the cylindrical process vessel to completely encircle the process vessel. In one embodiment, the drive tires radiate from the exterior wall of the cylindrical vessel and preferably terminate with a smooth exterior surface of the drive tire that makes contact with drive wheels to roll the drive tires so that the process vessel may be rotated about its longitudinal axis in either rotational direction. The drive tire arrangement represents an improvement over prior art devices in which the process vessel is rotated using either a large sprocket and chain drive mechanism or a large gear drive assembly attached to the vessel. The drive tire support structure that radiates from the exterior wall of the cylindrical vessel to the smooth exterior surface of the drive tire serves as the means to support the entire weight of the process vessel and its contents on the drive wheels. As the drive wheels turn while making contact with the drive tires on the process vessel, the drive tires rotate, which causes the process vessel to also rotate about its cylindrical axis. Further, the drive tire support structure, which in one embodiment extends radially from the process vessel wall, also serves as a thermal barrier between the exterior wall of the process vessel and the smooth exterior surface of the drive tires. The extended drive tire support structure may include a number of holes that provide additional surface area for heat dissipation and the holes may also serve as a conduit through which secondary steam distribution conduits may extend without interfering with the rotation of the process vessel by contact between the smooth exterior surface of drive tires and the drive wheels for rolling the drive tires.

In another embodiment, the process vessel may be loaded and unloaded while in the horizontal position, using the internal helical flight and rotation of the process vessel as the means to convey materials from the loading end to the opposite discharge end of the cylindrical process vessel in a continuous operation. Accordingly, the loading process fills the process vessel interior, and the processed materials are conveyed out of the process vessel interior when the discharge doorway is open.

In another embodiment, in which the cylindrical process vessel operates in a horizontal position, is the inclusion of a centering device mounted under the drive tire, preferably on the infeed end of the process vessel. The centering device includes a pair of rollers that are positioned on either side of the drive tire. If there is any movement of the process vessel on the drive wheel in either longitudinal direction (toward the infeed end or toward the discharge end), then the side of drive tire will contact one of the rollers on the centering device, preventing further movement in that direction. With the centering device, the drive tire has limited movement, for example, about 1 inch in either direction relative to the longitudinal length of the process vessel. Because the process vessel increases and decreases in length due to heating and cooling, it is impractical to include a centering device on both drive tires. Because most of the linear expansion and contraction takes place near the discharge end of the process vessel, the centering device is preferably located on the infeed end of the process vessel.

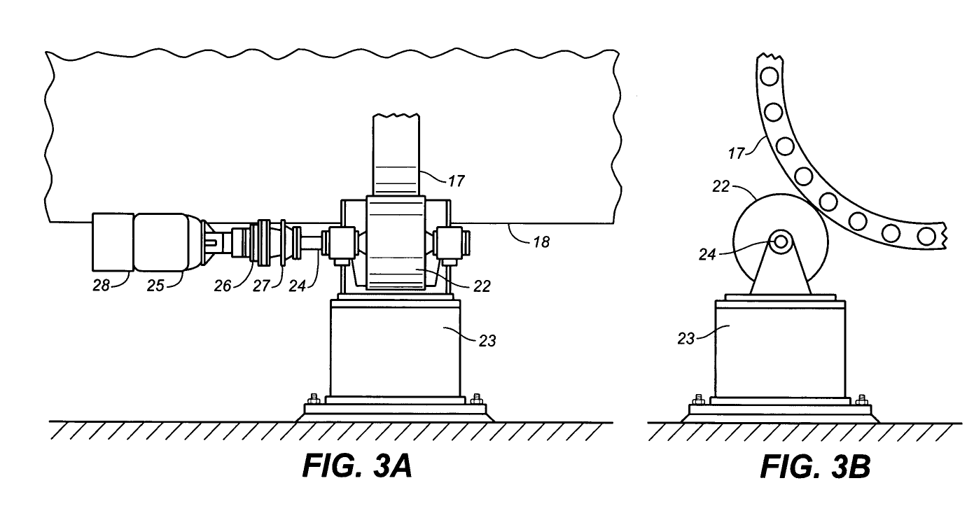

In another embodiment, the drive wheel assemblies support the entire weight of the process vessel and its contents. In the case of a process vessel with two drive tires, two drive assemblies may be used to support the process vessel at each drive tire. The drive assemblies are best positioned on opposite sides of the drive tire at a predetermined angle on the arc of the drive tire to equally support the weight of the process vessel and its contents, as illustrated in FIG. 3B. In one embodiment, the drive assemblies include a support drive base, which is mounted to the floor footings by large bolts. The floor footings support the weight of the process vessel and its contents. The upper section of the support drive base may be articulated to adjust the drive wheel such that the rolling surface of the drive wheel that makes contact with the drive tire of the process vessel is properly aligned so that the preferably smooth surfaces of both the drive wheel and drive tire make full face contact. Proper alignment ensures smooth operation and even weight distribution across the entire drive tire surface to prevent frictional wear and tear of the contact surfaces. The surfaces of the drive wheels in the drive bases should be wider than the drive tire to allow for thermal expansion of the process vessel along its longitudinal axis, especially for the drive wheel on the discharge end of the process vessel where the greatest expansion is experienced. The exterior surface of the drive tires is preferably constructed of metal having a hardness that is greater than that of the drive wheel contact surface, thus making the drive wheels easier and more economical to replace than the larger diameter drive tires. In one embodiment, the drive shaft that supports the drive wheel in the drive base is mounted in a pair of bearings, with one bearing on each side of the drive wheel to provide both a means of support for the drive shaft and a low friction turning mechanism for the drive shaft to rotate in the supporting drive base. The drive shaft extends from one side of the drive base to a gear reducer to provide a reduction from the speed of the drive motor to the desired speed of the drive wheel with sufficient torque to power the drive wheels. For example, the drive wheels may rotate the process vessel at a speed that ranges from about 0.1 to 10 revolutions per minute (“RPM”). In one embodiment, the drive shaft is equipped with a brake that may be engaged or released electronically, pneumatically or hydraulically. A drive motor and a drive motor cooling fan may be mounted on the gear reduction housing to provide means to power the rotation of the drive shaft. In one embodiment, the drive motors are controlled by a programmable logic computer (“PLC”) via electronic variable frequency drives (“VFD”). In one embodiment, each motor is controlled by a VFD configured such that one VFD serves as the “Master” and the other three drives respond to the Master VFD as “Followers” so that all four VFD units are synchronized with regard to current, torque, speed and direction. The PLC controls and monitors the performance of the drive motors. In one embodiment, the PLC thus controls the speed and direction of rotation of the process vessel.

Another embodiment includes means for introduction of steam and hot water into the process vessel interior during the process of loading the solid waste into the process vessel interior. Typically, the solid waste has an inherent moisture content of less than 50 percent by weight. Hot water may be added into the infeed end of the process vessel while solid waste is being discharged from the infeed conveyor. Hot water and steam may be added via steam sparging conduits and sparge holes by an additional vessel primary steam distribution conduit included on the discharge end of the process vessel. Steam may be introduced on the discharge end of the process vessel via a steam exhaust port in the discharge door to transfer heat and moisture into the solid waste as it is being added to the process vessel interior via the infeed end of the process vessel. The heated solid waste is conveyed toward the discharge end of the process vessel by the helical fighting during rotation of the process vessel directly into the path of the preheat steam entering via the steam exhaust port in the discharge door. As the solid waste makes contact with the steam being introduced via the steam exhaust port, the steam condenses, transferring heat and moisture into the components in the solid waste that absorb moisture. The absorbed moisture both softens the components and acts as a conduit for additional heat transfer from the condensing preheat steam. The condensing steam also transfers heat to low density/low temperature melting plastics causing such plastics, particularly low-density polyethylene (“LDPE”) bags, to soften and tear. The bags spill their contents, thus exposing more moisture absorbing solid waste to the condensing preheat steam. The introduction of preheat steam during the solid waste loading process promotes a compaction of the solid waste within the process vessel interior, thus allowing a larger quantity of solid waste to be added to the process vessel than would otherwise be possible in the absence of the introduction of preheat steam based on the original density of the solid waste. Adding hot water and preheat steam during the loading the solid waste thus increases the capacity of the process vessel for solid waste.

In another embodiment, multiple entry points are used to introduce steam into the process vessel interior by introducing steam via a steam exhaust port on the discharge door of the process vessel during the pressurization process in the same manner as during the solid waste loading process. Steam may be added via steam sparging conduits and sparge holes by an additional vessel primary steam distribution conduit included on the discharge end of the process vessel. Accordingly, a greater volume of steam is introduced from the vessel main steam supply conduit via the vessel primary steam distribution conduit, which may be connected to two or more external secondary steam distribution conduits. The external secondary steam distribution conduits may be connected via a penetration through the process vessel wall to internal steam sparging conduits. In one embodiment, the steam sparging conduits include small holes along their longitudinal length that allow steam to enter the process vessel interior via multiple entry points. Steam entering the process vessel interior via the sparging holes makes direct contact with the process vessel contents when the solid waste covers the sparging conduit and otherwise emits steam into the atmosphere of the process vessel interior when not covered by the solid waste. This process of adding steam directly to the solid waste and to the process vessel interior atmosphere is repeated with each revolution of the process vessel, which is in continuous rotation during the entire pressurization process. The vessel contents are also constantly lifted and dropped in a helical fashion along the length of the cylindrical process vessel which mixes the materials and repeatedly exposes the components to direct steam contact and an atmosphere of saturated steam. Accordingly, the vessel contents are rapidly and thoroughly exposed to the steam, which along with the heat, moisture, mixing, and pressure promotes the transformation process of the pulp and paper materials into the homogenous cellulosic biomass product.

In other embodiments, a variety of safety features are included. In one embodiment, the process vessel is designed, fabricated, and tested according to the codes of the American Society of Mechanical Engineers (“ASME”) or similar international organizations for such steam pressure process vessels. In one embodiment, the process vessel is designed, fabricated, and tested for a maximum operating pressure of saturated steam at 75 psig. For safety, one or more pressure relief valves may be included to prevent over-pressurizing the process vessel. In another embodiment, one or more stationary steam sources are equipped with steam pressure relief valves to prevent over-pressurizing. In one embodiment, a stationary steam conduit to the infeed end of the process vessel includes a manual steam safety valve between the stationary steam source and the process vessel. The manual valve may be used, for example, to shut off of the steam supply to the process vessel in the event of failure of the automatic steam inlet valve or to repair or remove and replace the automatic steam inlet valve or other components in the steam supply conduits or pressure vessel. In another embodiment, the stationary preheat steam conduit includes a manual preheat steam safety valve between the stationary steam source and the stationary exhaust conduit leading to the process vessel on the discharge end of the process vessel to shut off the steam supply to the process vessel manually in the event of failure of the automatic off-on preheat steam supply valve or to repair or remove and replace the automatic off-on preheat steam supply valve or other components in the preheat steam supply conduit or the stationary exhaust conduit. A further embodiment includes a manual exhaust safety valve in the stationary exhaust conduit between the process vessel and the exhaust condenser to manually shut off exhaust steam from the process vessel in the event of failure of the automatic exhaust flow control valve or to repair or remove and replace the automatic exhaust flow control valve or any other components in the stationary exhaust conduit.

In another embodiment, the PLC monitors the open or closed status of the manual safety valves and does not allow programmed procedures to proceed unless the safety valves are in the correct position. Other optional safety features include electrical interlocks on the door-lifting device to monitor the position of the device and its connection to the door. In one embodiment, the PLC monitors the door-lifting device position and determines whether it is connected to the door, thus preventing programmed procedures, such as turning the process vessel while the door-lifting device is connected to the door and the door is connected to the process vessel, from proceeding until all safety interlocks are in the appropriate settings. In another embodiment, the door sealing mechanism is controlled by the PLC and may not be activated to unseal and remove the door from the doorway unless the door-lifting device is attached to the door. In a further embodiment, the door sealing mechanism may not unseal the door until a manual safety lock has been released. The PLC may also include interlocks that prevent the process vessel from rotating until certain valves and switches are in the correct positions. In another embodiment, the drive motors may not be turned on until the drive motor cooling fans are on. In another embodiment, the automatic valves may not be opened or closed until the manual stems of the automatic valves have made contact with the PLC connector. A manual pressure relief valve may be included in the conduit between the rotary steam coupling and the detachable door on the discharge end of the vessel to prevent opening the door while the vessel remains under pressure and also to prevent a vacuum from forming within the vessel if it cools down while sealed or if the exhaust accelerator device actually pulls a vacuum on the vessel. The stationary steam and exhaust conduits may include bellows to allow some flexibility in the steam supply and exhaust conduits while the vessel is rotating and expanding or contracting to prevent rupture of stationary conduits.

Other embodiments include a variety of manual and electronic temperature and pressure measuring devices. Both manual and electronic temperature and pressure measuring devices may be included with the stationary steam source such that visual inspections may be made at the stationary steam source, or these measurements may be monitored and recorded by the PLC to ensure that the stationary steam source is operating within a predetermined temperature range and a predetermined pressure range. Such devices may also be included in the stationary steam conduit downstream from the steam pressure regulator for visual inspection and to monitor and record the steam pressure and temperature from the steam pressure regulator to the process vessel with the PLC. Such devices may also be included in the vessel primary steam distribution conduit for visual inspection and to monitor and record the temperature and pressure of the steam entering the process vessel with the PLC, which is also the steam pressure within the process vessel interior. Such devices may also be included in the stationary exhaust conduit for visual inspection and to monitor and record the temperature and pressure of steam exiting the process vessel via the stationary exhaust conduit with the PLC. Such devices may also be included on the exhaust condenser for visual inspection and to monitor and record the inlet and outlet temperature and pressure of the cooling water and the steam condensate with the PLC. Such devices may also be included on the non-condensable gas treatment system, such as a catalytic thermal oxidizer, for visual inspection and to monitor and record the inlet and outlet temperature of the gases and the catalytic oxidizer reaction chamber temperature with the PLC.

Other embodiments include a variety of features to facilitate operation and maintenance of the process vessel and ancillary equipment. In one embodiment, automatic valves are controlled by the PLC to save time and labor otherwise needed for operating manual valves. In one embodiment, sparging conduit bypasses and sparging conduit bypass valves are included in the steam sparging system. When the sparging conduit bypass valve is closed and steam is being introduced into the process vessel interior via the steam sparging conduit, steam flows through the sparging holes into the process vessel interior. When steam is not being introduced into the process vessel interior, such as during the process of loading waste into the process vessel interior and during the process of discharging processed materials from the process vessel interior, small particles of waste or processed materials may fall through the sparging holes into the steam sparging conduits and may accumulate to eventually hinder steam flow through the steam sparging conduits. During a subsequent pressuring up process, the sparging conduit bypass valve may be opened, which permits the majority of steam entering the steam sparging conduit to flow through the open conduit rather than through the sparging holes, thus cleaning out any debris that may have accumulated in the steam sparging conduit. Hot water mixed with steam at low pressures may also be used instead of steam alone for cleaning out debris from the sparging conduits via the sparging conduit bypass. After such cleaning out is accomplished, the sparging conduit bypass valve is closed, permitting steam to again flow through the sparging holes and into the process vessel interior. Other embodiments include the addition of clean-out ports on the secondary steam conduits and the steam sparging conduits in the event that the conduits become blocked with solid material that cannot be removed with steam or hot water pressure alone. Another improvement is the inclusion of an exhaust strainer over the exhaust port to prevent solid materials from the waste or processed materials from entering the exhaust conduit and damaging its various accessories, such as the automatic exhaust flow control valve or exhaust condenser.

Another embodiment includes an improved loading procedure that results in the introduction of a larger volume of solid wastes or MSW into the process vessel interior than would be expected based on its original density due to the compaction of the wastes that is facilitated by the addition of hot water and preheat steam during the process of introduction of such wastes, in addition to the rotation of the process vessel and its helical fighting, which conveys the wastes within the process vessel interior and mixes the wastes with the hot water and preheat steam. The loading procedure begins with the detachable door sealed in the doorway on the discharge end of the process vessel. The process vessel is rotated in the first rotational direction, and the helical fighting conveys materials away from the infeed end of the process vessel and toward the closed discharge end of the process vessel. Preheat steam is introduced into the process vessel interior, preferably via the exhaust port on the discharge door of the process vessel. Solid waste is introduced into the open doorway on the infeed end of the process vessel using a means of conveyance, and hot water is introduced intermittently into the process vessel interior in a predetermined ratio to the quantity of solid waste being introduced. Hot water and preheat steam may also be introduced via the steam sparging conduits and sparge holes by an additional vessel main steam distribution conduit included on the discharge end of the process vessel. As the process vessel interior fills with solid waste, the continuous rotation of the vessel and its helical flighting mixes the solid waste with the hot water and the preheat steam, resulting in a densification and compaction of the solid waste. In one embodiment, steam and gases released from the solid waste that are emitted from the open doorway of the process vessel are recovered in an overhead vent hood and vented to a non-condensable gas treatment system. When a predetermined quantity of solid waste has been introduced into the process vessel interior, the process vessel rotation is stopped, the means of conveyance of waste into the open doorway is stopped and withdrawn, and the door is placed into the doorway on the infeed end of the process vessel and sealed. The process vessel main steam supply conduit is connected to the vessel primary steam distribution conduit, and the process vessel is now prepared for pressurization.

In another embodiment, the process vessel is pressurized by multiple steam injection points for faster pressurization and a more complete saturation of the vessel contents with steam, which expands the molecular structure of the pulp and paper materials, making them more fragile and susceptible to transformation into the homogenous cellulosic biomass product. In one embodiment, the process vessel is sealed pressure tight and rotated in the second rotational direction that conveys the vessel contents away from the discharge end and toward the infeed end of the process vessel. In one embodiment, the PLC opens the automatic off-on preheat steam supply valve, which introduces steam via the exhaust port on the discharge door of the process vessel. In another embodiment, the PLC opens the automatic steam inlet valve over a predetermined time period to introduce steam via the steam sparging conduit and steam sparging holes. Thus, the process vessel interior and the waste materials are rapidly heated and saturated with steam, which is being introduced both directly into the solid waste materials covering the sparging holes and indirectly into the saturated steam atmosphere of the process vessel interior as the process vessel helical flighting rotates, conveying and mixing the materials to provide a thorough exposure of the vessel contents to the saturated steam. In one embodiment, when the process vessel reaches a pre-set internal pressure, for example, approximately 45-50 psig, the pressurization phase of the process ends, and the PLC automatically transitions into the cooking/purging phase of the process.

Another embodiment includes simultaneously heating the waste materials sufficiently to purge volatile organic compounds and other volatile air pollutants from the process vessel and its contents. In one embodiment, the process vessel is continuously rotated in the second rotational direction when the PLC closes the automatic off-on preheat steam supply valve upon reaching the pre-set pressure that ends the pressurization phase of the process. In one embodiment, the PLC partially opens the automatic exhaust flow control valve by approximately 5 percent. The automatic steam inlet valve remains open, thus forcing steam containing volatile organic compounds and other volatile air pollutants out of the slightly open automatic exhaust flow control valve. The elevated temperature in the process vessel interior vaporizes these volatile components of the wastes, and since they have a lower vapor pressure than steam, these volatile components are preferentially vaporized and exhausted from the process vessel interior. This contrasts with methods of the prior art in which volatiles are only vaporized and exhausted during the initial pressurization phase until the purged gases reach about 215° F. (about 102° C.) at which time the vent is closed. Using the partially opened valve, volatile organic compounds and other volatile air pollutants are purged from the solid waste in a temperature range of about 285-305° F. (140-150° C.). As a result, considerably more volatile components are vaporized and purged, typically for at least 20 minutes at these higher temperatures. Thus, essentially all of the volatile components vaporized under these conditions may be removed from the solid waste by the simultaneous heating/purging phase of the process. In one embodiment, condensable volatiles are removed from the exhaust vapors at an exhaust condenser and treated in a liquid effluent treatment system. The non-condensable volatiles are captured and treated in a gaseous emission treatment system to prevent release of such pollutants into the environment. In another embodiment, the pressure and temperature within the process vessel interior are monitored by the PLC. The PLC either opens or partially closes the automatic steam inlet valve to maintain the pressure and temperature in the process vessel interior within the desired ranges. After a pre-set time period, the heating/purging phase ends, and the PLC automatically transitions into the testing phase of the process.

Another embodiment includes determining whether additional heating/purging is necessary or may be bypassed to begin the depressurization phase of the process. At the end of the pre-set time period of the heating/purging phase, the PLC closes the automatic exhaust flow control valve for a brief period, then partially reopens the valve, for example, about 20-25 percent open for 10 seconds, then closes the valve again. The process vessel remains in continuous rotation in the second rotational direction, and the automatic steam inlet valve remains open during the testing phase. If the temperature of the exhausted steam rises or falls by some predetermined amount, for example 10° F. (5.5° C.) or more, from the temperature of the inlet steam, the PLC partially opens the automatic exhaust flow control valve, for example, about 5 percent open, and continues the heating/purging phase for an additional pre-set time period, for example, about 5 minutes. The temperature difference between the exhaust and inlet steam is indicative of the completeness of the cooking/purging phase of the process. In one embodiment, if the temperature of the exhaust is higher than the inlet steam by 10° F. (5.5° C.) or more, then there are volatile components remaining to be purged from the process vessel. If the temperature of the exhaust is lower than the inlet steam by 10° F. (5.5° C.) or more, then more moisture needs to be purged from the process vessel. If the temperature of the exhaust is within 10° F. (5.5° C.) of the inlet steam, then the processed solid waste products will be essentially free of volatile contaminants and the homogenous cellulosic biomass product will have a moisture content in the range of about 40-60 percent by weight, which facilitates the separation of the homogenous cellulosic biomass product from the other materials present in the processed solid waste or MSW during the materials separation phase of the process. This testing phase may be repeated several times, until the difference between exhausted steam temperature and the inlet steam temperature is less than 10° F. (5.5° C.). If the temperature difference is satisfactory on the first or any subsequent test, then the PLC closes the automatic steam inlet valve, which ends the testing phase, and the PLC transitions to the depressurization phase of the process.

In one embodiment, the depressurization phase of the process begins when the PLC slowly opens the automatic exhaust flow control valve to prevent excessive heat shock or sonic conditions in the exhaust conduit until the valve is fully open to depressurize the process vessel interior and its contents. In one embodiment, the process vessel remains in continuous rotation in the second rotational direction until the pressure of the process vessel and exhaust conduit has reached about 5 psig, at which pressure the manual exhaust relief valve is opened. The process vessel is rotated continuously until the pressure of the process vessel and exhaust conduit reach atmospheric pressure (zero psig).

Another embodiment includes an exhaust acceleration device in the stationary exhaust conduit. Such exhaust acceleration devices, which are commercially available, can significantly reduce the time period required for depressurization, which is important in maintaining a consistent, repetitive process cycle time for the process vessel. In one embodiment, the PLC activates the exhaust acceleration device when the PLC has completely opened the automatic exhaust flow control valve to promote the flow of steam from the process vessel interior by creating a large pressure differential between the process vessel interior and the exhaust conduit. The exhaust acceleration device maintains the large pressure differential as the pressure in the process vessel interior decreases, which reduces the overall time required for complete depressurization. A remote pressure/vacuum device is monitored by the PLC to deactivate the exhaust acceleration device and to open a vacuum relief safety valve in the exhaust conduit to prevent the process vessel from developing a significant vacuum. Once the process vessel has been completely depressurized, the PLC transitions to the unloading phase of the process.

In another embodiment, after the depressurization phase of the process is completed, the PLC stops the rotation of the process vessel, which has been preferably rotating in the second rotational direction since the beginning of the pressuring up phase. In the second rotational direction, the vessel contents are conveyed away from the discharge end and toward the infeed end of the process vessel. The vessel contents are reduced in volume generally by 50-75 percent by the transformation of the pulp and paper materials, food wastes, and soft yard wastes into the homogenous cellulosic biomass product, by the breakage of glass containers, by flattening and shrinkage of certain plastics, by melting and agglomeration of certain other plastics, and by other volume reducing phenomena. Accordingly, most of the vessel contents are near the infeed end of the process vessel interior. In contrast to devices of the prior art, the detachable door on the discharge end of the vessel may be removed from the doorway without the vessel contents interfering with its removal or the spillage of vessel contents prior to initiating vessel rotation. In one embodiment, the door-lifting device is positioned for removal of the detachable door on the discharge end of the process vessel and is connected to the door. The door is unsealed and removed from the doorway with the door-lifting device to a safe parking position. In one embodiment, the PLC activates the discharge conveyor under the process vessel discharge doorway and begins rotation of the process vessel in the first rotational direction, which conveys the contents away from the closed infeed end and toward the open doorway on the discharge end of the process vessel. In one embodiment, the processed materials exit the open doorway, fall onto the discharge conveyor, and are conveyed to the surge bin.

In another embodiment, the surge bin serves as a reservoir of processed materials for feeding a materials separation process. To be most effective, the surge bin should have the capacity for more processed materials than may be produced from one batch loading of a process vessel. Thus, a process vessel may be quickly emptied into the surge bin and begin a subsequent process cycle rather than using the process vessel as product storage for the feeding the materials separation process. The use of a surge bin allows the materials separation equipment to have a lower capacity for processing rather than being sized to rapidly empty the process vessel. The surge bin also allows the use of multiple process vessels, each operating in batch cycle mode, to be synchronized such that the supply of processed materials in the surge bin is intermittently replenished, but the excess capacity of the surge bin provides a continuous supply of processed materials feeding the materials separation process. Thus, the surge bin also serves as the transition point between a batch process for treatment of the solid waste in the process vessels and a continuous materials separation process.

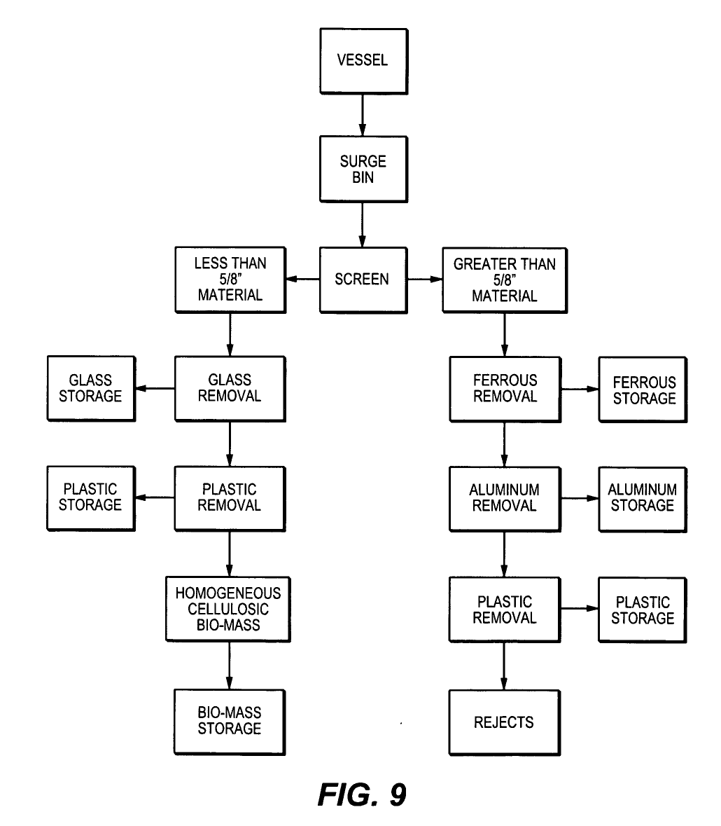

In other embodiments, various recyclables may be separated and recovered, including the homogenous cellulosic biomass. In the embodiment of FIG. 9, when the processed materials are conveyed to and stored temporarily in a surge bin, the homogenous cellulosic biomass is commingled with the other components of the solid waste or MSW, and materials separation is performed to separate and recover the homogenous cellulosic biomass, as well as other valuable components of the processed wastes, including ferrous metals, aluminum, and plastics. The commingled products are first conveyed to a screening device, such as a rotary trommel, to separate the materials based on particle size. The holes of the screen may be of almost any size and shape. In one embodiment, ⅝-inch square holes with maximum open area have been found to provide a relatively efficient and rapid separation. The oversized materials that are retained by the screen are further process by methods known in the art for removal of ferrous metals, aluminum, and plastics. The rejects from the oversized materials, which still contain textiles, wood, rubber, and leather, may be further separated, if economically feasible, however these commingled rejects may be used as a combustion fuel or simply disposed of in a landfill, as they typically comprise less than 20 percent of the original weight and volume of the solid wastes or MSW processed. The materials passing through the holes in the screen contain the homogenous cellulosic biomass product, which is still contaminated with broken glass, small pieces of plastic, and other small sized contaminants. Further materials separation to remove the glass and plastics yields the final homogenous cellulosic biomass product.

In other embodiments, other components of the solid waste or MSW, such as metals, plastics, and glass, are produced from the materials separation process in recyclable form that may be sold into recycling markets.

In other embodiments, a variety of end uses for the homogenous cellulosic biomass product may be implemented with or without further processing. One end use for the homogenous cellulosic biomass product is as a solid fuel for direct combustion or gasification, which may be accomplished as produced from the process vessel without drying. As a solid fuel, the homogenous cellulosic biomass may be also dried in bulk, briquetted, or pelletized for long-term storage or shipment. Another end use for the homogenous cellulosic biomass product is as a bulk insulation material by drying in a cyclonic dryer. Another end use for the homogenous cellulosic biomass is as an additive to concrete to produce a light weight concrete product that may be molded into a variety of products, such as concrete blocks, roofing tiles, etc. Another end use for the homogenous cellulosic biomass is as an additive to asphalt as a binding and bulking agent for elasticity of the asphalt product. Another end use for the homogenous cellulosic biomass product is to incorporate the product in drilling fluids as a lost circulation material or to produce high temperature and pressure drilling fluids for the oil drilling industry. The homogenous cellulosic biomass may also be further processed in a pulping and cleaning system to produce feedstock for the pulp and paper industry. Other end uses of the homogenous cellulosic biomass include thermal or chemical degradation of the cellulosic biomass into furfural, hydroxymethylfurfural, and levulenic acid and chemical or biological degradation into fermentable sugars for the production of ethanol, butanol, acetone, acetic acid, and a variety of other fermentation fuels and chemical products. Similar products may be produced by gasification of the cellulosic biomass and catalytic reformation of the synthesis gas. The end products described above may be produced generally with any suitable cylindrical process vessel.

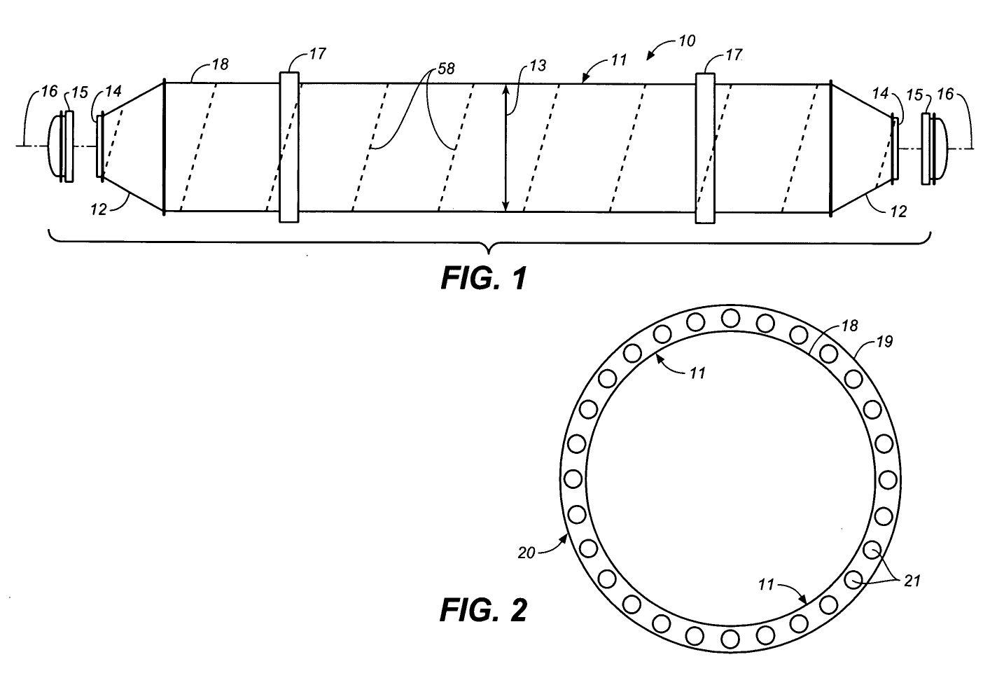

FIG. 1 illustrates a side view of a vessel for an apparatus for producing a homogenous cellulosic biomass product. The apparatus has been found highly suitable for treating solid waste containing diverse pulp and paper materials using the method described above to produce a homogenous cellulosic biomass product. As shown in FIG. 1, in this configuration, the process vessel, generally designated 10, includes a cylindrical housing 11 with conical ends 12 that are designed to gradually transition from the cylindrical housing diameter 13 of the cylindrical housing 11 to a smaller diameter doorway 14 at the intake end on the left and at the discharge end on the right. The cylindrical housing diameter 13 of the cylindrical housing 11 and the overall length of the cylindrical housing 11 are determined on the basis of the volume and density of the solid waste to be treated in a single batch loading of process vessel 10. Each doorway 14 has a detachable door 15 for closure of the doorway 14. The detachable doors 15 are lifted and moved with door lifting devices (not shown). The detachable doors 15 are equipped with a sealing mechanism (not shown) to allow the process vessel 10 to be pressurized with steam. Normally, the pressure does not exceed approximately 75 psig. In one embodiment, the process vessel 10 is designed, fabricated, and tested in accordance with American Society of Mechanical Engineers (“ASME”) or other similar international organizations' codes for such pressure vessels. As an example, for a process vessel 10 having a cylindrical housing diameter 13 of the cylindrical housing 11 of approximately 12 ft (approximately 3.64 m), and a doorway 14 diameter of approximately 6 ft (approximately 1.82 m), the conical ends 12 transition from the larger cylindrical housing diameter 13 of the cylindrical housing 11 to the smaller diameter of the doorway 14 according to current ASME code. The process vessel 10 is equipped with external means for rotation about its longitudinal axis 16. In one embodiment, further discussed below, the external means for rotation consists of one or more drive tires generally designated as 17. Embodiments including other external means for rotation of a process vessel known in the art, including but not limited to gear assemblies, may also be implemented by specific applications within the scope of the appended claims.

FIG. 2 illustrates a cross-sectional view of a drive tire support for the vessel of FIG. 1. As shown in FIG. 1 and the cross-sectional view of FIG. 2, the drive tires 17 are mounted perpendicular to the exterior wall 18 and to the longitudinal axis 16 of the cylindrical housing 11 and completely encircle the process vessel 10. The drive tires 17 radiate from the exterior wall 18 of the cylindrical housing 11 and preferably terminate with a smooth exterior surface 19 of the drive tire 17 that makes contact with means to rotate the drive tires 17 such that the process vessel 10 rotates about its longitudinal axis 16 in either rotational direction. The drive tire support structure 20 radiates from the exterior wall 18 of the cylindrical housing 11 to the smooth exterior surface 19 of the drive tires 17 to support the weight of the process vessel 10 and its contents on the means to rotate the drive tires 17. The drive tire support structure 20 also serves as a thermal barrier between the exterior wall 18 of the cylindrical housing 11 and the smooth exterior surface 19 of the drive tires 17. The drive tire support structure 20 may also include a number of holes 21 to provide additional surface area for heat dissipation and to serve as a conduit for secondary steam distribution conduits without interfering with the rotation of the process vessel 10 by contact between the smooth exterior surface 19 of drive tires 17 and the means for rotating the drive tires. In other embodiments, a number of drive tires other than two may be used to suit specific applications within the scope of the appended claims.

FIG. 3A illustrates a side view of a drive mechanism for the vessel of FIG. 1. In FIG. 3A, the drive tires 17 of the process vessel 10 in FIG. 1 are mounted on drive wheels 22 that are the means for rotating the drive tires 17 and the process vessel 10 in either rotational direction about its longitudinal axis 16. Applicant has found that four drive wheels 22 work well, two for each of the drive tires 17; however, a different number of drive wheels 22 may be used to suit specific applications within the scope of the appended claims. Each of the drive wheels 22 is mounted in a drive base 23 by its centrally disposed drive shaft 24. The drive bases 23, the drive wheels 22, and drive shafts 24 also serve as the structural support for the process vessel 10 and its contents by making contact with the drive tires 17.

FIG. 3B illustrates an end view of the drive mechanism of FIG. 3A. In FIG. 3, the drive bases 23 are anchored to the floor with large anchor bolts set in concrete footings and are equipped with means for adjustment of the drive wheels 22 in relation to the drive tires 17 for optimal alignment of the smooth exterior surface 19 of the drive tires 17 and the drive wheels 22. The drive wheels 22 are preferably aligned axially parallel to the cylindrical axis of the cylindrical process vessel 10. The drive shafts 24 of the drive wheels 22 are connected to a drive motor 25 via a gear reducer 26. The drive shaft 24 is equipped with a mechanical drive brake 27 that may be connected to either a hydraulic or pneumatic actuator (not shown) to engage or disengage the brake on the drive shaft 24. A drive motor fan 28 air-cools the drive motor 25. The size of the drive wheels 22, drive shafts 24, gear reducers 26, drive brakes 27, drive motors 25, drive motor fans 28, and drive bases 23 are determined according to well-known mechanical techniques in relation to the size of the drive tires 17 and the weight of the process vessel 10 and its contents. Seismic restraints (not shown) may be mounted in an arch over each drive tire 17 to prevent excessive movement of the process vessel 10 should a seismic event occur, thus retaining the drive tires 17 in contact with the drive wheels 22. A centering device (not shown) may be located under one drive tire 17 to prevent excessive movement of the process vessel 10 along its longitudinal axis during rotation in either rotational direction and during thermal expansion and contraction of the process vessel 10, thus maintaining full surface contact between the drive wheels 22 and the smooth outer surface 19 of the drive tire 17. Vessel lifting devices (not shown) may be used to lift the vessel at either end or both ends via the support structure 20 of the drive tires 17, thus preventing possible damage to the process vessel 10 by attempting to lift the process vessel 10 via the exterior wall 18 of the cylindrical housing 11.

Referring again to FIG. 1, the process vessel 10 is preferably equipped with one or more internal helical flights 58. The internal helical flights 58 are attached generally perpendicular to the interior walls of the cylindrical housing 11 and to the longitudinal axis 16 of the conical ends 12. The height, frequency, and number of internal helical flights 58 may be determined empirically. The internal helical flights 58 provide means for conveyance of the contents of the process vessel 10 and means for mixing the contents as the contents are lifted up the cylindrical wall against one side of the helical flights 58 and fall down when the contents reach an angle from the horizontal where they may no longer be retained against the surface of the helical flights 58 due to the rotation of the process vessel 10 about its longitudinal axis 16 in either rotational direction.

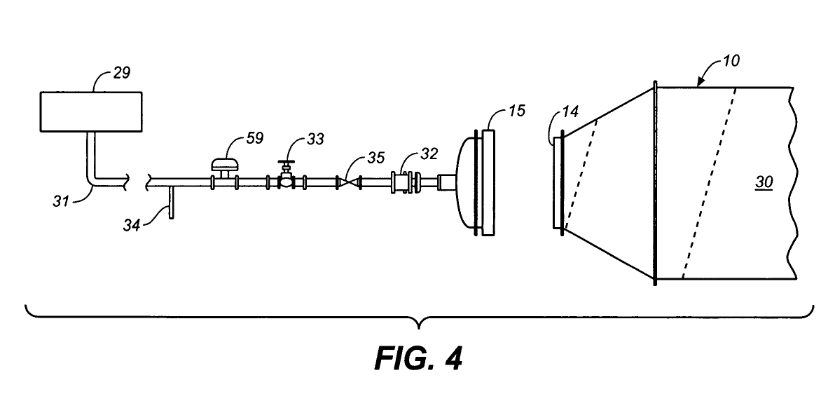

FIG. 4 illustrates a side view of a steam flow controller for the vessel of FIG. 1. In the embodiment of FIG. 4, the process vessel 10 is equipped with means for introduction of steam from a stationary steam source 29, such as a boiler, into the process vessel interior, generally designated as 30. Preferably the steam is introduced while the process vessel 10 is rotated in either rotational direction about its longitudinal axis 16. A stationary steam conduit 31 is connected between the stationary steam source 29 and a rotary steam coupling 32 that is centrally mounted on the detachable door 15. When the detachable door 15 is positioned and sealed in the doorway 14, the rotary steam coupling 32 serves as a means for connecting the stationary steam source 29 to the process vessel 10 such that the process vessel 10 may be rotated in either rotational direction and steam from the stationary steam source 29 may be introduced into the process vessel interior 30 of the rotating process vessel 10. The stationary steam conduit 31 is preferably equipped with a steam condensate trap 34 located at the lowest point in the stationary steam conduit 31 to remove steam condensate prior to the steam reaching the inline steam pressure regulator 59 in the stationary steam conduit 31 to regulate the steam pressure prior to introduction into the process vessel 10. The stationary steam conduit 31 is also preferably equipped with an inline manual steam safety valve 33 for emergency shutdowns of steam supply to the process vessel 10. In one embodiment, following the manual steam safety valve 33 is an inline automatic steam inlet valve 35 that is controlled by a programmable logic computer (PLC) to regulate the steam supply into the process vessel interior 30 in response to remote sensors for temperature and pressure (not shown).

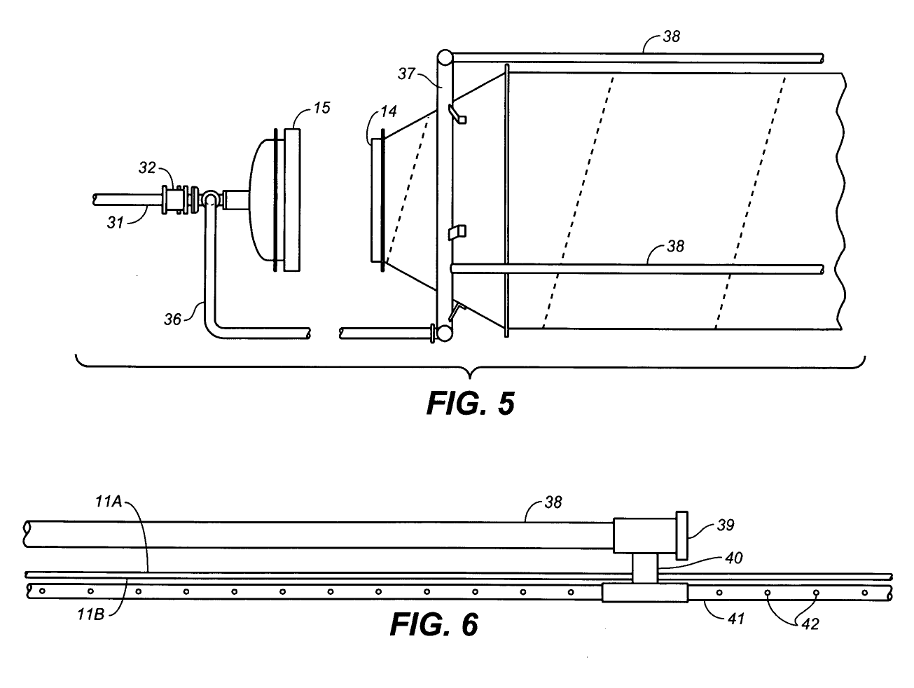

FIG. 5 illustrates a side view of a steam distribution conduit for the steam flow controller of FIG. 4. In the embodiment of FIG. 5, the infeed end of the process vessel 10 is shown with the steam supply from the stationary steam conduit 31 passing through the rotary steam coupling 32 and then to the vessel main steam supply conduit 36, which rotates with the process vessel 10 when the detachable door 15 is closed and sealed into the doorway 14 of the process vessel 10. The steam supply from the vessel main steam supply conduit 36 connects to the process vessel 10 via a union with the vessel primary steam supply distribution conduit 37, which is connected to two or more secondary steam distribution conduits 38 mounted on the exterior of the cylindrical housing 11 of the process vessel 10 and passing through the holes 21 in the support structure 20 of the drive tires 17 and thus do not interfere with the contact between the smooth exterior surface 19 of the drive tires 17 and the drive wheels 22 during rotation of process vessel 10 in either rotational direction about it longitudinal axis 16. In other embodiments, the secondary steam conduits 38 may be installed on the interior of the cylindrical housing 11 of the process vessel 10 via penetrations in the conical ends (not shown) and an additional vessel primary system distribution conduit 37 may be connected to the secondary steam conduits 38 on the discharge end of the process vessel 10 (not shown).

FIG. 6 illustrates a side view of a steam sparging conduit for the steam flow controller of FIG. 4. In the embodiment of FIG. 6, the secondary steam distribution conduits 38, which generally extend from the vessel primary steam distributor 37 parallel with and on the exterior of the cylindrical housing 11 to about the mid-point of the longitudinal length of the cylindrical housing 11, are connected to the process vessel interior 30 via a wall penetration conduit 40, such as a “T”, that passes through the wall of the cylindrical housing 11 perpendicular to the secondary steam distribution conduits 38. On the opposite side of the wall penetration conduits 40 from and in line with the secondary steam distribution conduits 38 is a secondary steam distribution conduit clean-out port 39. The wall penetration conduits 40 are also connected to the steam sparging conduits 41 that are mounted on the process vessel interior 30 of the cylindrical housing 11. The steam sparging conduits 41 are also connected perpendicular to the wall penetration conduits, such as a “T”, and the steam sparging conduits 41 are in parallel with the secondary steam distribution conduits 38 and the longitudinal axis 16 of the cylindrical housing 11. The steam sparging conduits 41 have a plurality of steam sparge holes 42 along their length for admitting steam into the process vessel interior 30. In other embodiments, the secondary steam conduits 38 may be installed on the interior of the cylindrical housing 11 of the process vessel 10 via penetrations in the conical ends (not shown) and an additional vessel primary steam distribution conduit 37 may be connected to the secondary steam conduits 38 on the discharge end of the process vessel 10 (not shown).

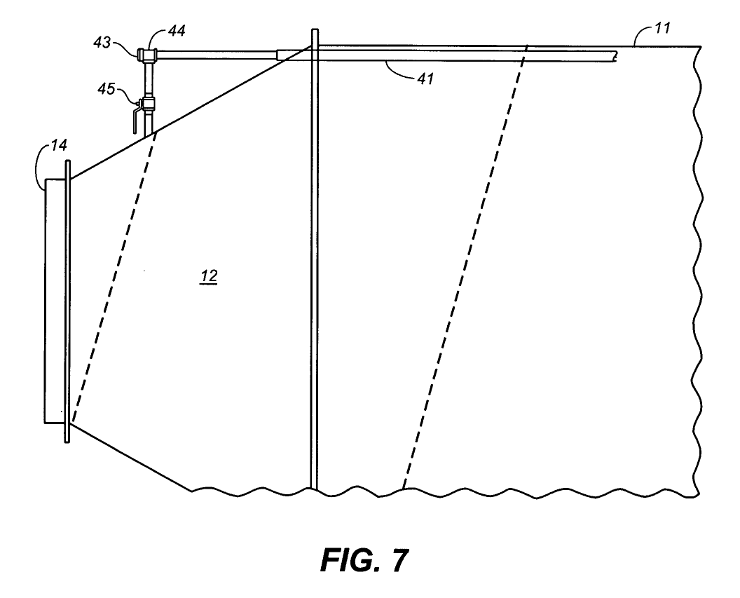

FIG. 7 illustrates a side view of a steam sparging conduit cleanout and bypass for the steam flow controller of FIG. 4. In the embodiment of FIG. 7, the steam sparging conduits 41 extend longitudinally beyond the length of the cylindrical housing 11, penetrate through the walls of the conical ends 12, extend beyond the exterior wall on the conical ends, and terminate with in line steam sparging conduit clean-out ports 43 on both ends of the process vessel 10. In conjunction with the steam sparging conduits clean-out ports 43, the steam sparging conduits 41 are connected to a steam sparging conduit bypass 44. The steam sparging conduit bypass 44 is perpendicular to the steam sparging conduits 41, includes an inline manual bypass valve 45, runs perpendicular to the longitudinal axis 16 of the process vessel 10, and penetrates through the wall of the conical ends 12. The purpose of the steam sparging conduit bypass 44 is to manually divert the flow of steam and/or hot water at low steam pressures through the steam sparging conduits 41, thus allowing steam to bypass the steam sparge holes 42, and to use the steam and/or hot water pressure and flow through the larger diameter steam sparging conduit bypass 44 as a means to pneumatically and/or hydraulically remove debris from the steam sparging conduits 41 that may accumulate by backflow of solid material through the steam sparge holes 42 when there is no steam pressure and flow in the steam sparging conduits 41.

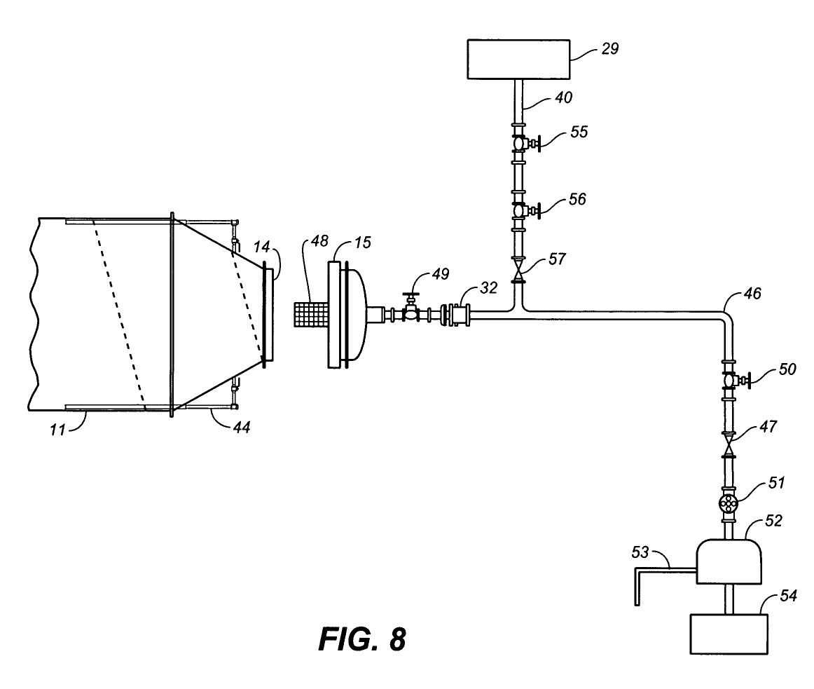

FIG. 8 illustrates a side view of an exhaust and preheating system for the steam flow controller of FIG. 4. The discharge end of the process vessel 10 shows the process vessel exhaust and preheat system. The detachable door 15 on the discharge end of process vessel 10 has a central penetration connecting the process vessel 10 with the stationary exhaust conduit 46 via a rotary steam coupling 26 through which pressurized steam may be exhausted from the process vessel interior 30 by opening an inline automatic exhaust flow control valve 47, which is connected to the PLC, thus allowing the process vessel 10 to be vented or depressurized while rotating in either rotational direction via the stationary exhaust conduit 46. The stationary exhaust conduit 46 also includes an inline manual exhaust safety valve 50 for emergency shutoffs. In addition, the stationary exhaust conduit 46 includes an exhaust accelerator device 51, such as a turbine, to increase exhaust flow from the process vessel interior 30 as the pressure inside the process vessel decreases. Steam vented via the stationary exhaust conduit passes through an inline non-contact exhaust condenser 52 to remove condensable steam, volatile organic compounds, and other volatile components. The condensate from the exhaust condenser 52 is carried by the steam condensate conduit 53 to a liquid treatment system (not shown) for removal and destruction of pollutants from the condensate. The non-condensable gases from the exhaust condenser 52 are directed to a gaseous treatment system, such as a catalytic thermal oxidizer 54 or other suitable device for destruction of volatile organic compounds, and other volatile components. There is an exhaust strainer 48 covering the central penetration on the process vessel interior 30 side of the detachable door 15 of the process vessel 10 to capture any solid debris that may be carried in the exhaust steam during the steam purge and depressurization processes. The exhaust strainer 48 preferably has a perforated screen covering. The exhaust strainer 48 may also be used with a disk or baffle (not depicted) to dissipate the steam from the incoming steam line. The section of exhaust conduit on the exterior side of the detachable door 15 that rotates with the process vessel when the detachable door 15 is in the closed and sealed position in the doorway 14 includes a manual relief valve 49 to insure the vessel pressure is completely discharged (zero pressure, psig) and also to prevent a vacuum from forming in the process vessel interior 30 as the process vessel 10 and its contents cool down below 212° F. (100° C.).

In the embodiment of FIG. 8, a preheat steam conduit 40 is connected to the stationary exhaust conduit 46 via a series of inline valves 55, 56, and 57 so that with the automatic exhaust flow control valve 47 in the stationary exhaust conduit 46 in the closed position and the inline valves 55, 56, and 57 in the preheat steam conduit 40 in the open position, preheat steam may be introduced into the process vessel interior 30 via the central penetration in the detachable door 15 on the discharge end of the process vessel 10. The inline manual preheat safety valve 55 is used for emergency shutoff of the steam supply. The inline manual adjustable preheat steam flow control valve 56 is used to regulate the volume of steam flowing through the preheat steam conduit 40. The automatic off-on preheat steam supply valve 57 allows the flow of steam to be turned off or on by the PLC. It is also possible that an additional vessel primary steam distribution conduit 37 may also be connected to the secondary steam conduits 38 on the discharge end of the process vessel 10 (not shown) to provide a source of hot water and steam into the process vessel interior 30. The introduction of preheat steam into the process vessel interior 30 from the otherwise closed discharge end of the process vessel 10 is particularly valuable during the process of loading solid waste into process vessel interior 30 via the open doorway 14 on the infeed end while rotating the process vessel 10.

In preparation for performing the improved method for treating solid waste containing diverse pulp and paper materials for producing a homogenous cellulosic biomass product, some operations regarding the removal and replacement of the detachable doors 15 are performed manually while the programmable logic computer (PLC) performs most other operations automatically. Assuming that a previous process run has been completed, the detachable doors 15 on both ends of the process vessel 10 may be removed. In one embodiment, the detachable doors 15 are connected to the door-lifting devices (not shown) and are positioned some distance from the doorways 14 of the process vessel 10, referred to as a safe parking position, thus the detachable doors 15 do not interfere with various operations taking place at the doorways 14 during the process cycle. The detachable door 15 on the discharge end of the process vessel 10 is moved from the safe parking position and is positioned with the door-lifting device (not shown) for closure of the doorway 14. The detachable door 15 is placed in the doorway 14 and secured with the door sealing mechanism (not shown). The door-lifting device is disconnected from the detachable door 15 and moved into the safe parking position. The stationary exhaust conduit 46 is connected to the rotary steam coupling 32 and the manual relief valve 49 is closed. The manual preheat steam safety valve 55 is opened, and the manual adjustable preheat steam flow control valve 56 is adjusted to a predetermined open setting. The automatic off-on preheat steam supply valve 57 is manually opened, but the PLC maintains the automatic off-on preheat steam supply valve 57 in the off or closed position. The manual exhaust safety valve 50 and the automatic exhaust flow control valve 47 are manually opened, but the PLC maintains the automatic exhaust flow control valve 47 in the closed position. The PLC is then activated to control the automatic off-on preheat steam supply valve 57 and the automatic exhaust flow control valve 47.

In preparation for introducing solid waste containing diverse pulp and paper materials into the process vessel interior 30 via the doorway 14 on the infeed end of the process vessel 10, the detachable door 15 is connected to the door-lifting device and is positioned in a safe parking position some distance away from the doorway 14. A means for introducing solid waste from a source (not shown) to the process vessel 10, such as a continuous belt conveyor (not shown), is inserted into the infeed end doorway 14 a sufficient distance to prevent spillage of solid waste. In one embodiment, the PLC changes the automatic off-on preheat steam supply valve 57 to the on or open position, and preheat steam begins to flow from the stationary steam source 29 through the exhaust strainer 48 on the discharge end of the process vessel 10, although steam may be introduced by other means and in other places. The preheat steam flow rate is preferably in the range of 3,000-5,000 pounds/hour. In one embodiment, the PLC initiates rotation of the process vessel 10 in a first rotational direction at a predetermined speed of about 6 rpm, whereby the internal flight(s) 58 acts as a means of conveyance to move the solid waste away from the infeed end and toward the discharge end of the process vessel 10, which is closed and sealed by the detachable door 15 in the doorway 14 on the discharge end. The solid waste is thus introduced into the process vessel interior 30 via a means of continuous introduction from a source that is inserted into the doorway 14 on the infeed end while the process vessel 10 is rotating in the first rotational direction to convey the introduced solid waste away from the infeed end and to the discharge end. In one embodiment, the quantity of solid waste being conveyed into the process vessel interior 30 is weighed continuously and monitored by the PLC. As the solid waste is being conveyed into the process vessel interior 30, an intermittent stream of hot water is added in a predetermined proportion to the quantities of solid waste being conveyed. In one embodiment, the quantity of hot water is added automatically by the PLC according to one of three choices: 7 percent by weight for wet wastes; 10 percent by weight for normal wastes; and 13 percent by weight for dry wastes. In other embodiments, other percentages may be used. The solid waste is exposed to both moisture and heat by the addition of hot water and preheat steam, which begins the process of transformation of the solid waste.

As the solid waste reaches the discharge end of the process vessel 10, which is closed, the process vessel interior 30 begins to fill, and this introduction of solid waste continues until a predetermined amount of solid waste has been introduced into the process vessel interior 30. During the continuous introduction of solid waste, the process vessel 10 is continuously rotating in the first rotational direction, which results in a continuous mixing of the solid waste with both the hot water and preheat steam and thus promotes densification and compaction of the solid waste, which allows the addition of more waste than would be possible based on the initial density of the solid waste being introduced. When the predetermined amount of solid waste has been introduced into the process vessel interior 30, the means of introduction of solid waste from the source is stopped and withdrawn from the doorway 14, the PLC changes the automatic off-on preheat steam supply valve 57 to the off or closed position, and the PLC stops rotation of the process vessel 10.

Referring again to FIG. 5, the detachable door 15 on the infeed end of the process vessel 10 is moved from the safe parking position and is positioned with the door-lifting device (not shown) for closure of the doorway 14. In one embodiment, the detachable door 15 is placed in the doorway 14 and secured with the door sealing mechanism (not shown). The door-lifting device is disconnected from the detachable door 15, and the door-lifting device moved into the safe parking position. The stationary steam conduit 31 is connected to the rotary steam coupling 32, and the vessel main steam supply conduit 36 is connected to the vessel primary steam distribution conduit 37. In one embodiment, the PLC initiates rotation of the process vessel 10 in the second rotational direction, which conveys the solid waste away from the discharge end and to the infeed end of the process vessel 10, where the doorway 14 on the infeed end of the process vessel 10 is now closed by the detachable door 15 and sealed, and the PLC opens the automatic off-on preheat steam supply valve 57.

Referring back to FIG. 4, the manual steam safety valve 33 and the automatic steam inlet valve 35 are opened manually. In one embodiment, the PLC controls the opening of the automatic steam inlet valve 35, and the PLC incrementally opens the automatic steam inlet valve 35 over a predetermined time interval of 10-20 minutes until fully open. For a 25-ton batch load of MSW, the combined steam flow rate from the preheat steam inlet and the main infeed inlet into the process vessel interior 30 is in the range of 15,000-25,000 pounds/hour. In one embodiment, the PLC continuously monitors the temperature and pressure via remote sensors until the pressure within the process vessel interior 30 reaches a predetermined pressure in the range of 45-60 psig. When the PLC senses that the predetermined pressure within the process vessel interior 30 has been reached, the PLC closes the automatic off-on preheat steam supply valve 57 and opens the automatic exhaust flow control valve 47 to a predetermined setting of 2 percent-10 percent open. In one embodiment, the PLC continuously monitors the temperature and pressure of the steam in the stationary exhaust conduit 46 on the discharge end of the process vessel 10 via remote sensors, and when the temperature in the stationary exhaust conduit 46 reaches a predetermined set point with the temperature in the range of 285-305° F., the PLC regulates the flow of steam into the process vessel interior 30 by closing or opening the automatic steam inlet valve 35 on the infeed end of the process vessel 10.

The continuous flow-through of steam into the process vessel interior 30 via the automatic steam inlet valve 35 and from the process vessel interior 30 via the partially opened automatic exhaust flow control valve 47 purges volatile organic compounds and other volatile components from the solid waste contents of the process vessel interior 30. The purged steam, volatile organic compounds, and other volatile components contained in the solid waste and vaporized by the heat and pressure within the process vessel interior 30 with the continuous mixing of the contents of the process vessel interior 30 due to the rotation of the process vessel 10 are passed through an exhaust condenser 52, where condensable components are removed and the non-condensable volatiles are directed to a catalytic thermal oxidizer 54 or other suitable volatile treatment system to render the volatile organic compounds and other volatile components harmless to the environment. In one embodiment, the condensable components from the exhaust condenser 52 are treated in a liquid treatment system to render any pollutants harmless to the environment.

After a predetermined period of time of steam flow-through, normally approximately 20-30 minutes, a test cycle is performed. In one embodiment, the PLC closes the automatic exhaust flow control valve 47 for a brief time period and then re-opens the automatic exhaust flow control valve 47 to a predetermined open setting for a time period sufficient to determine the difference, if any, in temperature of the steam flowing through the stationary exhaust conduit 46 on the discharge end of the process vessel 10 compared to the temperature of the steam flowing through the automatic steam inlet valve 35 on the infeed end of the process vessel 10. The PLC then closes the automatic exhaust flow control valve 47. If the exhaust steam temperature differs from the inlet steam temperature by more than some desired amount, for example, 10° F. (5.5° C.), the PLC again partially opens the automatic exhaust flow control valve 47, and the steam flow-through process is continued for an additional specified time period. At the end of the additional specified time period, the test cycle is repeated as described above. If the temperature difference is again greater than 10 degrees F. (5.5 degrees C.), the steam flow-through process is repeated one additional time. If the temperature difference is less than 10 degrees F. (5.5 degrees C.) on the first or second test cycle or after the second additional steam flow-through time period, then the PLC closes the automatic steam inlet valve 35 on the infeed end of the process vessel 10, and the PLC then slowly opens the automatic exhaust flow control valve 47 on the discharge end of the process vessel 10 until fully open to depressurize the process vessel.

In one embodiment, hot water at approximately 200° F. is added while the solid waste material is being loaded. The amount of hot water added depends on whether the load is considered “wet”, “normal”, or “dry”, and is often determined by visual inspection by the operator. Hot water is preferably added as the solid waste is loaded. Steam is also normally added during the loading process at a rate of approximately 5000 lbs/hour, preferably from the discharge end, and the process vessel 10 is normally rotated at about 5-7 rpm. Once the door 15 is closed, additional steam is added, normally at a total rate of approximately 20,000 lbs/hour. In one embodiment, about 15,000 lbs/hour is added at or near the infeed end, and about 5,000 lbs/hour is added at or near the discharge end. The rotation of the vessel during this time is preferably approximately 3-4 rpm. With the vessel closed, the vessel pressure increases, starting from 0 psig and rising up to approximately 40-45 psig, which normally takes approximately 20-30 minutes. The process is then run at pressure for about 20-30 minutes.

As the steam pressure in the process vessel interior 30 decreases to a predetermined pressure in the range of 25-50 psig, the PLC may initiate the exhaust accelerator device 51 to facilitate the depressurization process over a period of 20-30 minutes. When the pressure of the process vessel interior reaches a pre-set pressure of 1-2 psig, the PLC turns off the exhaust accelerator device 51 and sounds an alarm to open the manual relief valve 49. When the flow of steam from the manual relief valve 49 outlet ceases, and the pressure of the process vessel interior 30 is at zero psig, the PLC stops the process vessel rotation for removal of the detachable door 15 from the doorway 14 on the discharge end of the process vessel 10.

In one embodiment, the door-lifting device is moved from the safe parking position and connected to the detachable door 15 on the discharge end of the process vessel 10. The door sealing mechanism is released and the detachable door 15 is removed from the doorway 14 and moved to the safe parking position. A means for moving the processed materials that are discharged from the doorway 14, such as a continuous belt conveyor, is activated by the PLC. The PLC then initiates rotation of the process vessel 10 in the first rotational direction to convey the processed materials via the helical flightings 58 away from the infeed end and to the discharge end of the process vessel 10. After several revolutions of the process vessel 10 in the first rotational direction, the PLC may stop vessel rotation for removal of the detachable door 15 from the doorway on the infeed end of the process vessel 10, if desired. The door-lifting device is moved from the safe parking position and connected to the detachable door 15 on the infeed end of the process vessel 10. The door sealing mechanism is released and the detachable door 15 is removed from the doorway 14 and moved to the safe parking position. The PLC again initiates rotation of the process vessel 10 in the first rotational direction at a rate of 4-6 rpm to discharge the contents of the process vessel interior 30. Having the open doorways 14 on both ends of the vessel provides a means for more rapidly cooling the processed materials as they are mixed and conveyed by the helical fighting 58 due to the process vessel rotation. In one embodiment, both ends of the process vessel 10 are located under vent hoods with draft fans (not shown) to vent the fugitive steam and volatiles that escape from the open doorways 14 during both the loading and unloading processes. The vapors from the vent hoods are directed to the volatile treatment system to remove volatile organic compounds and other volatile components.

In another embodiment, the processed solid waste discharged from the process vessel 10 via the doorway 14 on the discharge end of the process vessel 10 is transported by means such as a continuous belt conveyor (not shown) to a surge bin (not shown) for subsequent materials separation. After all of the processed solid waste is discharged from the process vessel interior 30, the vessel rotation is stopped in position for replacement of the detachable door 15 in the doorway 14 on the discharge end of the process vessel 10. Assuming that there is no additional processing to be initiated, the entire system may be shut down. In another embodiment, repetitive processing resumes as follows. After the processed solid waste is discharged from the process vessel interior 30, the vessel rotation is stopped in position for replacement of the detachable door 15 in the doorway 14 on the discharge end of the process vessel 10, and the door-lifting device (not shown) with the detachable door 15 connected is moved from the safe parking position and into position for fitting the detachable door 15 into the doorway 14. The detachable door 15 is positioned into the doorway 14 and sealed. The door-lifting device is disconnected from the detachable door 15 and the door-lifting device is moved into the safe parking position. The stationary exhaust conduit 46 is connected to the rotary steam coupling 32, and the automatic exhaust flow control valve 47 is closed by the PLC. The PLC opens the automatic off-on preheat steam supply valve 57 and initiates vessel rotation in the first rotational direction to begin loading the process vessel interior 30 via the doorway 14 on the infeed end of the process vessel 10 as described above.

FIG. 9 illustrates a flow chart for the separation of materials from the processed solid waste discharged from the process vessel of FIG. 1. In the embodiment of FIG. 9, various recyclables may be separated and recovered. The commingled processed solid waste, including the homogenous cellulosic biomass, is subjected to a materials separation system, which in one embodiment is generally represented in FIG. 9. In this embodiment, the commingled processed materials are conveyed to a screening device, such as a rotary trommel with ⅝-inch square holes. The homogenous cellulosic biomass product passes through the holes in the screen, along with 5%-10% by weight broken glass, small bits of plastic, and some other small sized contaminants. Further separation of the homogenous cellulosic biomass product is not necessary for some applications, such as solid combustion or gasification fuel, but for other applications removal of the broken glass is desirable, and for still other applications the plastics are also removed. The homogenous cellulosic biomass product may then be dried to less than 10% moisture by weight for long-tenn storage or shipment in bulk or may be briquetted or pelletized to reduce volume and weight prior to shipment. FIG. 9 also includes some examples of the separation of the materials greater than ⅝-inch that are rejected by the screen, which includes for example, magnetic removal of ferrous metals, eddy current removal of non-ferrous metals, optical or manual removal of plastics, and final rejects. Other separation methods known in the art may be used to accomplish separation of the various components, and are within the scope of this invention. The final rejects may be further separated to remove textiles, wood, leather, rubber, etc if desired, or simply shredded and either used in bulk as a solid fuel for combustion or gasification. In another embodiment, the final rejects may be transported to a landfill for disposal.

### Outline for Safe Operation

The following procedure provides an outline for the safe operation of process vessel 10 described above with reference to FIGS. 1-8 and includes all equipment and unit operations beginning with MSW delivered to the Tipping Floor and proceeding through the MSW Loading Process, the Steam Treatment Process, and the Processed Materials Separation Process. The Trommel Screen fines will be fed into a 40 ft. roll-off container or the Hydropulper as the terminal step in the Front End Process.

Personnel with specific position assignments (see below) will report to their respective positions for start-up, and ALL other plant personnel, contractors, and spectators are barred from the work area, especially from the Infeed and Discharge Work Platforms, unless specifically requested by the Autoclave Operator (AO):

Autoclave Operator (AO) is in charge of all operations regarding the front-end process, particularly the vessels and boilers, which includes supervising the TFLO, IFO, and DFO. The AO functions as the PLC/Control Room Operator.

Tipping Floor Loader Operator (TFLO) is in charge of all operations with regard to MSW handling, which includes maintaining an adequate MSW inventory on the tipping floor and in the walking floor conveyor, operating the Front Loader, overseeing the pre-sort of MSW on tipping floor, and loading the walking floor conveyor, to keep the process vessels in continuous operation. The TFLO also orders and directs the delivery of MSW to the Tipping Floor and manages the removal of unprocessable material from the Tipping Floor and process rejects from the Rejects Conveyor.

Tipping Floor Utility (TFU) assists the TFLO with regard to all tipping floor operations, which includes tipping floor maintenance, removal of unprocessible materials from the MSW, and any other operations as requested by the TFLO.

Infeed Floor/Platform Operator (IFO) is in charge of all operations that take place at the infeed end of the vessels, which includes removal/replacement of the Vessel Infeed Doors, insertion/retraction of Infeed Conveyors, and any other manual operations as required regarding the infeed floor and platform area.

Infeed Floor/Platform Assistant (IFA) assists the IFO with all operations at the infeed end of the process vessels.

Discharge Floor/Platform Operator (DFO) is in charge of all operations that take place at the discharge end of the vessels, which includes setting the Pre-Heat Steam Valve, bleeding the 4″ Decompression Valve, removal/replacement of the Discharge Doors, communicates with AO regarding vessel discharge speed, and any other manual operations related to discharge of processed materials from the vessel to the Discharge Conveyor. The IFO will also function as the DFO in a two-vessel plant.

Discharge Floor/Platform Assistant (DFA) assists the DFO with all operations at the discharge end of the vessels. The IFA also functions as the DFA in a two-vessel plant.

Commodity Floor Operator (CFO) oversees the Materials Separation Equipment, which includes inspection and maintenance of all belt and walking floor conveyors, removal and disposal of textiles and other rejects from conveyors, inspection an maintenance of rotary trommel and removal and disposal-of cellulosic biomass product, inspection and maintenance of belt magnet, eddy current, and manual commodity separation equipment and/or personnel, and inspection and disposal of sorted commodities from bins and dumpsters.

Manual Sorter/Utility (MSU) will assist the TFLO and TFU in sorting and removing unprocessible from the MSW on the Tipping Floor. MSU will also assist the CFO in the removal and disposal of textiles and other rejects from Materials Separation Equipment, and general maintenance of Materials Separation Area.

Maintenance/Contractors will conduct required general maintenance on equipment and will be on stand-by for emergency assistance or repairs.

### Example of Operating Procedure

Outlined below is an example of the methods and procedures for treating solid waste. The process outlined below includes a number of optional steps that Applicant includes in the description, but are not limitations of the invention. Also, the various time periods, temperatures, and pressures are not limitations of the invention, but rather just one embodiment.

AO/IFO will confirm by visual inspection and/or PLC readings that the Phase 8—Discharge Completion Process for closure of the Vessel Discharge Door has been satisfactorily completed, which means:

Discharge Platform-

Movable Platform is under Vessel and is in contact with Limit Switch (visual & PLC)

Movable Platform is secured in position with pins (visual only)

Discharge Door-

Vessel Discharge Door is closed and secure (visual only)

Door Safety Lock is engaged and locked (visual only)

Exhaust Hammerlock Fitting is secured (visual & physical check)

Exhaust Anti-Rotation Trolley is in position and secured with the C clamp (visual only)

4″ Decompression Valve is closed (visual only),

Hydraulic Lines are disconnected (visual only)

Door Lifting Device is disconnected from Door (visual & PLC)

Door Lifting Device is parked in the safe area (visual & PLC)

Discharge Control Panel-

Vessel Discharge Conveyor (#6) OFF/ON Switch is in OFF position (visual & PLC)

Discharge Hydraulic Power Pack OFF/ON Switch is in OFF position (visual & PLC

Vessel Discharge AUTO/OFF Switch is in AUTO position (visual & PLC)

Floor Level in Front of Discharge Platform-

Air Supply Valve to Pre-Heat Steam Solenoid Valve and Exhaust Steam Automatic Valve is open and showing pressure on middle gauge, if no pressure, open valve (visual only)

Pre-Heat Steam Maintenance Valve is open (visual only)

Pre-Heat Steam Safety Valve is closed (visual & PLC)

Exhaust Steam Safety Valve is closed (visual & PLC)

Floor Level in Front of Infeed Platform-

Air Supply Valve to Infeed Steam Automatic Valve is open and showing pressure on middle gauge, if no pressure, open valve (visual only)

Infeed Steam Maintenance Valve is open (visual only)

Infeed Steam Safety Valve is closed (visual & PLC)

Infeed Platform-

Vessel Infeed Door is open (visual only)

Infeed Hydraulic Lines are disconnected (visual only)

Infeed Door Lifting Device is parked in the safe area (visual & PLC)

Infeed Retractable Conveyor (#4) is fully retracted (visual & PLC)

Infeed Control Panel-

Infeed Retractable Conveyor OFF/ON Switch is OFF (visual & PLC)

Infeed Hydraulic Power Pack OFF/ON Switch is OFF (visual & PLC)

Vessel Infeed AUTO/OFF Switch is in AUTO position (visual & PLC)

This process outlines a cold start heat-up procedure. Therefore, the AO/IFO will start the Boilers approximately 10 minutes prior to intended start time of the Vessel Loading Procedure.

Boiler Start-Up Procedure-

IFO opens Manual Steam Trap Bleed Valve, ball valve at floor level near rear stairs of Infeed Platform (visual only)

IFO opens Manual Steam Line Drain Valve, orange gate valve at eye level on I-beam near boiler water treatment units (visual only)

IFO confirms Boiler Water Softener Valves are open (visual only)

IFO confirms Boiler Water Resin Filter Valves are open (visual only)

IFO connects Boiler Chemical Feed Pump Plug (visual only)

IFO confirms all 3 Boiler Feed Water Valves are open (visual only)

IFO confirms all 3 Gas Supply Valves are open (visual only)

IFO confirms Screw Compressor and Filter Unit are on (visual only)

IFO turns on Toggle Switches on all 3 Boilers (visual only)

IFO presses all 3 Ignition Switches to start Boilers (visual only)

IFO closes Manual Steam Drain Line Valve (visual only)

IFO closes Manual Steam Trap Bleed Valve (visual only)

When boilers are at pressure (approximately 10 min), the cold start vessel heat up procedure can begin with:

Floor Level in Front of Discharge Platform-

IFO confirms that the Pre-Heat Steam Maintenance Valve is open (visual only)

IFO confirms with AO that the Exhaust Steam Safety Valve is open (visual & PLC)

IFO confirms with AO that the Exhaust Steam Automatic Valve is open (visual & PLC)

IFO confirms with AO that the Pre-Heat Steam Solenoid Valve is closed (visual & PLC)

IFO confirms with AO that the Pre-Heat Steam Safety Valve is open (visual & PLC)

IFO confirms Pre-Heat Steam Flow Control Valve is opened 100% (visual & physical)

### Phase 1—Infeed Preparation

IFO notifies AO that Vessel is ready for the Loading Procedure to be initiated. Infeed Door must be off and parked in the safe area to proceed with Loading Procedure.

AO clicks “BEGIN. CYCLE” button that appears (on PLC screen)

PLC closes Exhaust Steam Automatic Valve (PLC only)

PLC opens Pre-Heat Steam Solenoid Valve (PLC only)

Floor Level in Front of Infeed Platform-

IFO confirms with AO that the Infeed Steam Safety Valve is in the closed position (visual & PLC)

Pick Heater (Floor Level in Front of Infeed Platform)-

IFO confirms the air supply valves to Water Feed Solenoid Valve and Steam Feed Automatic Valve and Dump Valve are open (visual only)

IFO confirms with AO that the Water Feed Solenoid and Steam Feed Automatic and Dump Solenoid Valves are closed (visual & PLC)

IFO confirms Pick Heater Manual Water Feed Safety Valve is open (visual only)

IFO confirms Pick Heater Manual Steam Feed Safety Valve is open (visual only)

IFO confirms Pick Heater Manual Dump Safety Valve is open (visual only)

IFO confirms Pick Heater Manual Hot Water Discharge Valve is open (visual only)

IFO requests that AO open the Dump Solenoid Valve for 10 seconds to relieve any pressure and drain line condensate to either Conveyor (visual only)

IFO opens the Manual Hot Water Supply Safety Valve to either Conveyor (visual only)

Infeed Control Panel-

IFO advances the Infeed Retractable Conveyor into Vessel by pressing the Conveyor Advance button (visual & PLC)—Advance conveyor until extended into the vessel to 13 ft. mark on side.

### Phase 2—Filling of Vessel

PLC Control Room-

IFO notifies AO when the Infeed Retractable Conveyor is inserted into Vessel (visual & PLC)

AO enters the weight set point for loading MSW on pop-up screen (PLC only)

PLC begins rotation of Vessel at 3 rpm in the discharge direction (counterclockwise from infeed end) (visual & PLC)

TFLO and AO confer on PLC cook recipe. AO then selects either the wet, normal, or dry recipe. PLC calculates total amount water to be added in gallons per ton

PLC automatically ramps up vessel speed to 6.0 rpm (PLC only)

IFO moves the Infeed Retractable Conveyor OFF/ON Switch to the ON position which sequentially starts the loading conveyors with 10 second delays (visual & PLC)

PLC opens the Pick Heater Water Feed Solenoid Valve intermittently and adds 10% of the total amount of hot water set by the PLC recipe after each addition of 10% of total MSW weight set point (PLC only)

PLC monitors the temperature of the Pick Heater Hot Water RTD which controls the Steam Feed Automatic Valve to maintain Pick Heater hot water discharge at 200 degree F. (PLC only)

PLC monitors the MSW total batch weight and stops the Walking Floor Conveyor when the set point weight is achieved (PLC only)

Boilers-

AO inspects Boiler Pressure Gauge on I-beam at Manual Boiler Steam Trap for pressure of 130 or higher (visual only)

AO inspects all 3 boilers for pressure and continuous operation

Infeed Platform-

IFO visually monitors the loading process and e-stops the Infeed Retractable Conveyor, if necessary (visual only)

When the set point weight of MSW is reached, the PLC stops the Loading Conveyors in the reverse order with 10 second delays to clear the belts (PLC only)

IFO observes the Vessel and coordinates any additional MSW loading with AO (visual & PLC)

IFO notifies AO when the Vessel fill is completed (visual & PLC)

IFO moves Infeed Conveyor OFF/ON switch to OFF

IFO retracts the Infeed Retractable Conveyor to its fully retracted position (visual & PLC)

PLC senses the Infeed Retractable Conveyor Limit Switch for full retraction and disables the conveyor system (visual & PLC)

IFA closes the Pick Heater Steam Safety Valve at Floor Level in Front of Infeed Platform (visual only)

IFO moves the Vessel Infeed AUTO/OFF Switch to the OFF position (visual & PLC)

PLC slows Vessel rotation to 2 rpm, if running faster than 2 rpm

PLC stops the Vessel rotation at TDC and sets air brakes (PLC only)

If not at TDC, AO releases air brakes, Vessel is allowed to settle gravitationally, and then IFO uses jog button to set TDC (visual only)

IFO and AO confirm that Vessel is at TDC, and AO sets air brakes (visual & PLC & opcon)

PLC closes Pre-Heat Steam Solenoid Valve (PLC only)

PLC opens Exhaust Steam Automatic Valve 50% (PLC only)

PLC enables and lights Infeed Hydraulic Power Switch (visual & PLC)

IFA wipes off the Infeed Door sealing surfaces and closely inspects to insure removal of all magnetic or other debris (visual & physical)

IFO operates the Infeed Door Lifting Device to position the Infeed Door for closure (visual & PLC)

IFA connects Infeed Hydraulic Lines to Door Cam Lock (visual only)

IFO moves Infeed Door Hydraulic OFF/ON Switch to ON & closes the Door Cam Lock with Hydraulic Toggle Handle (visual only)

IFO inspects the Infeed Door for proper closure (visual only)

IFO engages and locks the Infeed Door Safety Lock (visual only)

IFO unlocks both chain binders on Trifeed Steam Line (visual only)

IFO and IFA position the Infeed Steam Line Hammerlock Fittings to align with their Stationary Steam Line counterparts and make the necessary connections and unhook both chain binders from Infeed Steam Line (visual only)

IFO inspects and secures the Infeed Steam Line Hammerlock Fittings and secures the Anti-Rotation Device (visual & physical)

IFO moves the Infeed Hydraulic OFF/ON Switch to the OFF position (visual & PLC)

IFA disconnects the Hydraulic Lines from the Door Cam Lock (visual only) May need to toggle hydraulic handle to relieve pressure

IFA removes pin and clip to disconnect Lifting Device from Door (visual & PLC)

IFO retracts the Infeed Door Lifting Device from the Vessel Door

Receiver and relocates and parks the Lifting Device in the safe area (visual & PLC)

IFO confirms with the AO that the Infeed Door Lifting Device is parked in the safe area (visual & PLC)

IFO notifies AO that the Vessel Infeed Door is sealed and that the area is secure

IFO confirms that the 1″ Bleed Valve on Steam Infeed Line is closed (visual only)

IFA opens the Infeed Steam Safety Valve and confirms with AO (visual & PLC)

IFO moves the Vessel Infeed AUTO/OFF Switch to the AUTO position (visual & PLC)

PLC sounds horn, delays, and then begins Vessel rotation in the non discharge direction at 2 rpm (counterclockwise rotation from infeed end (PLC only)

### Phase 3—Pressure Up Cycle

PLC Control Room-

PLC closes the Exhaust Steam Automatic Valve (PLC only)

PLC opens Pre-Heat Steam Solenoid Valve (PLC only)

PLC gradually opens the Main Infeed Steam Valve as programmed (approximately 15 min for warm starts or approximately 20 min for cold starts) (visual & PLC)

PLC ramps Vessel up to 3 rpm at 25 psig and when Infeed Steam Automatic Valve is 100% open (PLC only)

PLC controls Main Infeed Steam Valve until exhaust pressure reaches 50 psig (PLC only)

### Phase 4—Cook Cycle

PLC switches the control from pressure up to cook cycle (PLC only)

PLC closes Pre-Heat Steam Solenoid Valve (PLC only)

PLC slightly opens Exhaust Steam Automatic Valve to 5% for 15 min and begins to control exhaust steam valve, not to exceed 15% open (PLC only)

PLC monitors the exhaust temperature to control the Infeed Steam Automatic Valve to maintain minimum temperature of 290° F. and maximum temperature of 305° F. (PLC only)

If high temperature alarm pop-up appears on PLC screen, AO notifies IFO to immediately close the Infeed Steam Safety Valve (physical & PLC)

PLC monitors the cook cycle time to completion and proceeds to Test Cycle below (PLC only)

### Phase 5—Test Cycle

PLC closes Main Infeed Steam Valve and maintains rotation in the non discharge direction (PLC only)

PLC strokes the Exhaust Steam Automatic Valve to open full for 10 seconds and then closes to the normal control position (15% open) (PLC only)

PLC monitors the temperature drop in the Vessel Exhaust Line during rapid depressurization, and determines if additional cook time is needed (PLC only)

PLC either adds time to the internal clock and returns to cook cycle above, or continues in exhaust cycle below (PLC only)

### Phase 6—Exhaust Cycle

PLC indicates that exhaust cycle is in process (PLC only)

AO notifies IFO to close Main Infeed Steam Safety Valve and IFO confirms Main Infeed Steam Safety Valve closure with AO (physical & PLC)

PLC monitors the Vessel exhaust pressure and ramps Exhaust Steam Automatic Valve open, based on time or backpressure to depressurize the Vessel (PLC only)

PLC monitors backpressure and alarms PLC to notify AO that exhaust is approaching

PLC announces low pressure set point (4 psi) exhaust pressure to AO (PLC only) IFA confirms reading on Discharge Pressure Gauge to AO (visual only)

IFA gradually opens the 4″ Decompression Valve while Vessel is still rotating (visual only)

AO acknowledges IFA's visual and physical report that the 4″ Decompression Valve and clicks button on PLC screen (visual & PLC)

PLC indicates pressure at 0 psi for both the Main Infeed Steam Line and the Exhaust Steam Lines (PLC only)

IFA confirms with AO that exhaust gauge indicates zero pressure (visual only)

IFO closes Exhaust Steam Safety Valve and Pre-Heat Steam Safety Valve and confirms closure with AO (physical & PLC)

IFA confirms with AO that exhaust flow from 4″ Decompression Valve is not continuous (visual only)

### Phase 7—Discharge of Vessel

IFO notifies AO that unloading is to be initiated (visual only)

IFO switches the Vessel Discharge OFF/AUTO Switch to OFF and confirms with AO (physical & PLC)

PLC rotates Vessel to TDC position and set air brakes (PLC only)

If not at TDC, AO releases air brakes, vessel is allowed to settle gravitationally, and IFO uses jog button to set TDC (physical only)

IFO and AO confirm that Vessel is at TDC, and AO sets air brakes (visual & PLC & opcon)

IFO positions the Discharge Door Lifting Device to remove the Vessel Discharge Door, connects the Lifting Device to the door, and pins the door

IFO confirms with AO that the Vessel door is connected to lifting device (physical & PLC)

PLC lights and enables Vessel Door Hydraulic Power Switch (PLC only)

IFA disconnects the steam connection at Hammerlock Fitting (physical only)

IFA disconnects anti-rotation trolley and secures the chain to release Exhaust Line for relocation with Discharge Door Lifting Device (physical only)

IFA connects Hydraulic Lines to Vessel Discharge Door (physical only)

IFA unlocks and disengages the Discharge Door Manual Safety Lock (physical only)

IFO moves Hydraulics Power Pack OFF/ON Switch to ON and operates Door Cam Lock to open Discharge Door (physical only)

IFO operates the Discharge Door Lifting Device to relocate door and park in the clear area (physical only)

IFO confirms with AO that Discharge Door Lifting Device is parked in the clear area (visual & PLC)

IFA switches hydraulic power switch to OFF (physical only)

IFA relieves the pressure on the hydraulic toggle & disconnects the hydraulic lines from the door (physical only)

IFO and IFA retract Movable Platform from under Vessel to discharge area and secure Platform with pins (physical only)

IFO and AO confirm Movable Platform is moved and secured (physical & PLC)

IFO moves Discharge Conveyor ON/OFF switch to the ON position and IFO confirms with AO that Vessel Discharge Conveyor is ON (visual & PLC)

IFO moves the Vessel Discharge AUTO/OFF Switch to the AUTO position (visual & PLC)

AO notifies IFO that Vessel discharge is enabled (visual & PLC)

PLC sounds horn, delays, and then begins Vessel rotation in the discharge direction at 2 rpm (counterclockwise rotation from infeed end) for at least 1.5 minutes or 3 revolutions (PLC only)

### Infeed Platform

IFO moves the Vessel Infeed AUTO/OFF Switch to the OFF position (physical only)

PLC continues to rotate the Vessel to the Infeed TDC position (PLC only)

If not at TDC, AO releases air brakes, vessel is allowed to settle gravitationally, and IFO uses jog button to set TDC (physical only)

IFO and AO confirm that Vessel is at Infeed TDC, and AO sets air brakes (visual & PLC & opcon)

IFO positions the Infeed Door Lifting Device to remove the door, connects the device to the door, and pins the Infeed Door and confirms with AO (physical & PLC)

PLC lights and enables the Door Hydraulic Power Switch (PLC only)

IFA opens the 1 ” steam relief valve and disconnects the steam line anti rotation device (physical only)

IFO and IFA open the steam connections at the Hammerlock Fittings and connect both chain binders to Infeed Steam Line (physical only)

IFA connects the hydraulic lines to the Infeed Door (physical only)

IFO unlocks and disengages the Infeed Door Manual Safety Lock (physical only)

IFO moves the hydraulic power pack ON/OFF switch to the ON position (physical only)

IFO engages the Hydraulic unit power pack to open the Door (physical only)

IFO removes the Infeed Door with Door Lifting Device, relocates the Lifting Device, and parks in the safe area (physical only)

IFO confirms with AO that Lifting Device is parked in the safe area (visual & PLC)

IFO disconnects Hydraulic Lines and turns Hydraulic Power Unit switch OFF (physical only)

IFO and AO confirm that the Material Handling System is operating (visual & PLC)

IFO changes the position of the Vessel Infeed AUTO/OFF Switch to the AUTO position (physical only)

PLC sounds horn, delays, and then begins Vessel rotation in the discharge direction at 2 rpm (PLC only)

At the direction of the IFO, AO gradually increases vessel rotational speed to maximum rpm to discharge vessel contents (visual & PLC)

### Phase 8—Completed Discharge

Discharge Platform

IFO notifies AO that Vessel discharge has been completed (visual only)

IFO confirms with AO that the Pre-Heat Steam Safety Valve and the Exhaust Steam Safety Valve are in the closed position (visual & PLC)

IFO and IFA move Vessel platform into door handling position under Vessel and secure with pins (physical & PLC)

IFO moves Vessel Discharge Conveyor OFF/ON Switch to OFF position (physical & PLC)

IFO moves the Vessel Discharge Auto/Off Switch to the OFF position (physical & PLC)

PLC continues Vessel rotation to the TDC position on Discharge door (PLC only)

PLC lights and enables Vessel Discharge Door Hydraulic Power Switch (PLC only)

IFA wipes off Vessel door sealing surfaces, and IFO operates door-lifting device to position Discharge Door for closing (physical only)

IFA connects hydraulic hoses to Vessel door closing device (physical only)

IFO energizes Hydraulic Power Unit for Vessel door closure (physical only)

IFO inspects Vessel door for proper closure and manually engages Safety Lock (physical only)

IFA disconnects hydraulic lines from door (physical only)

IFA positions movable steam line to align with stationary steam line and closes the hammerlock fitting (physical only)

IFA positions and secures anti-rotation trolley (physical only)

IFO inspects steam line and hammerlock fittings for proper condition (physical & visual)

IFO notifies AO that Discharge Door is sealed and area is secure (visual only)

IFO confirms that the 4” Decompression Valve is closed (physical & visual)

IFO disconnects Vessel door lifting device from door, relocates the Vessel door-lifting device and parks in the safe area (physical only)

IFO and AO confirm that the Discharge door lifting device is parked in the clear area (visual & PLC)

IFA moves discharge door hydraulic power ON/OFF switch to the OFF position (physical only)

IFO moves Vessel discharge panel AUTO/OFF switch to the AUTO position and confirms with AO (physical & PLC)

Floor Level in Front of Discharge Platform

IFO opens Exhaust Steam Safety Valve and confirms with the AO (physical & PLC)

IFO opens Pre-Heat Steam Safety Valve and confirms with the AO (physical & PLC)

What is claimed is:

1. An apparatus for treating solid waste to produce a biomass product comprising:
a cylindrical vessel comprising a loading doorway and a discharge doorway at opposite ends of the cylindrical vessel;
a first detachable door for loading the solid waste into the cylindrical vessel and for sealing the loading doorway under pressure;
a second detachable door for unloading the biomass product from the cylindrical vessel and for sealing the discharge doorway under pressure;
a helical flighting affixed to an interior wall of the cylindrical vessel for mixing and agitating the solid waste or the biomass product and for conveying the solid waste and the biomass product between the loading doorway and the discharge doorway when the cylindrical vessel is rotated around a cylindrical axis of the cylindrical vessel;
at least two drive tires mounted on the cylindrical vessel perpendicular to the cylindrical axis, the drive tires each comprising a smooth exterior surface for rotating the cylindrical vessel on the drive mechanism without gear teeth and without sprocket teeth; and
a drive mechanism coupled to the drive tires for rotating the cylindrical vessel around the cylindrical axis; the drive mechanism further comprising drive wheels that support and provide torque to the cylindrical vessel from a contact surface on each of the drive wheels that contacts the exterior surface of the drive tires.

2. The apparatus of claim 1, the cylindrical vessel comprising a diameter between 1.8 m and 3.65 m.

3. The apparatus of claim 1, the loading doorway comprising a diameter between 1.2 m and 1.8 m.

4. The apparatus of claim 1, the discharge doorway comprising a diameter between 1.2 m and 1.8 m.

5. The apparatus of claim 1 further comprising the drive tires mounted on the cylindrical vessel at a predetermined distance from the opposite ends to support the cylindrical vessel on the drive mechanism.

6. The apparatus of claim 5 further comprising a number of holes in the drive tires for dissipating heat from the cylindrical vessel to reduce heat transfer from the cylindrical vessel to the exterior surface of the drive tires.

7. The apparatus of claim 6 further comprising secondary steam distribution conduits that extend through the holes without interfering with the rotation of the cylindrical vessel on the drive mechanism.

8. The apparatus of claim 1 further comprising a conical reduction in diameter at each end of the cylindrical vessel terminated by the loading doorway or the discharge doorway.

9. The apparatus of claim 1 further comprising the first and second detachable doors being completely removable from the cylindrical vessel so that the cylindrical vessel may be rotated around the cylindrical axis with only one of the first and second detachable doors detached, with both of the first and second detachable doors detached, and with both of the first and second detachable doors sealed to the cylindrical vessel.

10. The apparatus of claim 1 further comprising the helical flighting as sole means for agitating the solid waste and the biomass product and for conveying the solid waste and the biomass product between the loading doorway and the discharge doorway when the cylindrical vessel is rotated around the cylindrical axis.

11. An apparatus for treating solid waste to produce a biomass product comprising:
means for subjecting the solid waste to a flow of pressurized steam comprising a loading doorway and a discharge doorway at opposite ends of a cylindrical vessel;
means for loading the solid waste into the cylindrical vessel and for sealing the loading doorway under pressure;
means for unloading the biomass product from the cylindrical vessel and for sealing the discharge doorway under pressure; and
means affixed to an interior wall of the cylindrical vessel for agitating the solid waste and the biomass product and for conveying the solid waste and the biomass product when the cylindrical vessel is rotated around a cylindrical axis of the cylindrical vessel;
means comprising a smooth exterior surface for rotating the cylindrical vessel on the drive mechanism without gear teeth and without sprocket teeth mounted on the cylindrical vessel perpendicular to the cylindrical axis; and
means for rotating the cylindrical vessel around the cylindrical axis comprising a drive wheel that supports and provides torque to the cylindrical vessel from a contact surface that contacts the smooth exterior surface.

12. The apparatus of claim 11 further comprising a drive mechanism for rotating the cylindrical vessel around the cylindrical axis in a first direction while loading the solid waste to convey the solid waste away from the loading doorway.

13. The apparatus of claim 12 further comprising a drive mechanism for rotating the cylindrical vessel in the first direction while unloading the biomass product to convey the biomass product out of the cylindrical vessel through the discharge doorway.

14. The apparatus of claim 13, the drive mechanism further comprising means for maintaining the cylindrical vessel in a horizontal position without tilting the cylindrical vessel while loading and unloading the cylindrical vessel.

15. The apparatus of claim 13, the drive mechanism further comprising means for rotating the cylindrical vessel in a second direction to convey the solid waste toward the loading doorway.

16. The apparatus of claim 11 further comprising the drive wheel having a contact surface that is wider than the exterior surface of the drive tire to allow for thermal expansion of the cylindrical vessel.

17. The apparatus of claim 16 further comprising the exterior surface of the drive tire constructed of a metal having a hardness that is greater than that of the contact surface of the drive wheel.

18. The apparatus of claim 12, the drive mechanism further comprising:
a drive base;
a pair of bearings secured into and on either side of the drive base; and
a drive shaft supported on the drive base by the pair of bearings whereon the drive wheel is mounted; and
means for rotating the drive shaft in the drive bearings.

19. The apparatus of claim 18, the means for rotating further comprising:
a gear reducer coupled to the drive shaft; and
an electric motor to rotate the drive wheels.

20. The apparatus of claim 19, the means for rotating further comprising a drive brake coupled to the drive shaft.

21. The apparatus of claim 1 further comprising:
a steam exhaust port on the second detachable door;
a steam exhaust valve port for coupling to a source of steam; and
a steam exhaust valve coupled to the steam exhaust valve port for introducing steam into the cylindrical vessel via the exhaust port during the loading of the solid waste.

22. The apparatus of claim 11 further comprising the drive wheel aligned axially parallel with the cylindrical axis.

23. The apparatus of claim 21 further comprising a rotary union on the second detachable door coupling the source of steam to the cylindrical vessel via the steam exhaust port while the vessel is rotated in either rotational direction about its longitudinal axis.

24. The apparatus of claim 1 further comprising:
a main steam supply conduit;
at least two external secondary steam distribution conduits mounted outside the cylindrical vessel;
a primary steam distribution conduit mounted on the first detachable door coupling the main steam supply conduit to the external secondary steam distribution conduits.

25. The apparatus of claim 24 further comprising internal steam sparging conduits connected to the external secondary steam distribution conduits via penetrations through the cylindrical vessel.

26. The apparatus of claim 25 further comprising:
a stationary steam source coupled to the cylindrical vessel by the main steam supply conduit; and
a steam pressure relief valve coupled to the stationary source of steam.

27. The apparatus of claim 26 further comprising a manual steam pressure relief valve between the rotary union and the second detachable door.

28. The apparatus of claim 27 further comprising:
sparging conduit bypasses coupled to the internal steam sparging conduits; and
sparging conduit bypass valves coupled to the sparging conduit bypasses.

29. The apparatus of claim 28 further comprising clean out ports coupled to the secondary steam distribution conduits and the steam sparging conduits to provide means for manual clean out of debris.

30. The apparatus of claim 24 further comprising an exhaust strainer mounted inside the steam exhaust port to prevent solids from passing through the steam exhaust port.

31. The apparatus of claim 30 further comprising a steam pressure regulator coupled to the stationary steam source for maintaining steam pressure to the cylindrical vessel within a predetermined range.

32. The apparatus of claim 31 further comprising a manual steam safety valve coupled to the stationary steam source for manually shutting off steam from the stationary steam source.

33. The apparatus of claim 24 further comprising a manual steam safety valve coupled to the steam exhaust valve port for manually shutting off steam from the cylindrical vessel.

34. The apparatus of claim 24 further comprising a steam pressure relief valve coupled to the steam exhaust valve port.
